(19) United States
(12) Patent Application Publication
(10) Pub. No.: US 2015/0285973 A1
(43) Pub. Date: Oct. 8, 2015

(54) PHOTOSENSITIVE RESIN COMPOSITION, COLOR FILTER AND METHOD FOR MANUFACTURING THE SAME, AND LIQUID CRYSTAL DISPLAY APPARATUS

(71) Applicant: Chi Mei Corporation, Tainan City (TW)

(72) Inventors: Wei-Kai Ho, Nantou County (TW); Jung-Pin Hsu, Tainan City (TW)

(21) Appl. No.: 14/668,998

(22) Filed: Mar. 26, 2015

(30) Foreign Application Priority Data
Apr. 2, 2014 (TW) 103112336

(51) Int. Cl. G02B 5/22; G02F 1/1335

(52) U.S. Cl. CPC G02B 5/223; G02F 1/133516; G02F 2001/133519

(57) ABSTRACT

A photosensitive resin composition, a color filter and a method for manufacturing the same, and a liquid crystal display apparatus are provided. The photosensitive resin composition includes a compound (A) containing an ethylenically unsaturated group, an alkali-soluble resin (B), a photoinitiator (C), a pigment (D), and an organic solvent (E). The compound (A) containing an ethylenically unsaturated group includes a first compound (A-1) containing an ethylenically unsaturated group. The first compound (A-1) containing an ethylenically unsaturated group has two or more groups represented by formula (1) and does not have an aromatic skeleton. The photosensitive resin composition has the advantages of high precision pattern linearity and good alkali solution resistance.

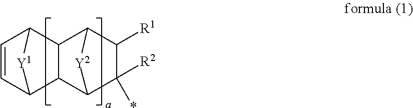

### CROSS-REFERENCE TO RELATED APPLICATION

This application claims the priority benefit of Taiwan application serial no. 103112336, filed on Apr. 2, 2014. The entirety of the above-mentioned patent application is hereby incorporated by reference herein and made a part of this specification.

### BACKGROUND OF THE INVENTION

1. Field of the Invention

The invention relates to a photosensitive resin composition, a color filter and a method for manufacturing the same, and a liquid crystal display apparatus. More particularly, the invention relates to a photosensitive resin composition for a color filter having high precision pattern linearity and good alkali solution resistance, a color filter manufactured thereby and a method for manufacturing the same, and a liquid crystal display apparatus.

2. Description of Related Art

Currently, the color filter has been widely used in applications such as color liquid crystal displays, color facsimile machines, and color cameras. With the ever expanding market demand for office equipment such as the color liquid display, the production of the color filter is also technically diversifying. For instance, methods such as the staining method, printing method, electrochemical plating method, and dispersion method have all been gradually developed, with the dispersion method currently being the mainstream.

In the process of the dispersion method, a pigment is first dispersed in a photosensitive resin to form a photosensitive resin composition, followed by coating the photosensitive resin composition on a glass substrate. After the steps of, for instance, exposure and development, a specific pattern can be obtained. After repeatedly performing the processes of, for instance, coating, exposure, and development three times, the desired red (R), green (G), and blue (B) pixel color patterns can be obtained in the pixel color layers of the color filter. Generally, to further increase the contrast of the color filter, a shading layer (also referred to as a black matrix) can further be disposed between the pixel color layers formed by the pixels.

In the dispersion method, the photosensitive resin composition used is, for instance, exemplified by using a copolymer polymerized from a monomer component of (meth)acrylic acid as an alkai-soluble resin of the photosensitive resin composition. Relevant literature of the photosensitive resin composition includes, for instance, Japanese Patent Publication No. H6-95211, Japanese Unexamined Patent Publication No. H8-183819, and Japanese Unexamined Patent Publication No. H9-311210.

However, in recent years, as personal digital assistants and digital cameras become more compact and lighter, color filters need to be lighter, thinner, and have higher color saturation. Therefore, the concentration of the colorant in the colored composition needs to be increased. However, if the concentration of the colorant is increased, then the amount of resin in the photosensitive resin composition is relatively decreased. When the resin component facilitating adhesion is decreased, the adhesion between the pixels and the shading layer is decreased such that the pixels are readily peeled off, thereby causing poor high precision pattern linearity.

In this regard, as mentioned in Japanese Laid-Open No. 2001-075273, a photosensitive resin composition used has a polymer obtained by polymerizing an unsaturated monomer containing a carboxyl group with a monomer containing glycidyl group, wherein the polymer is used as the alkali-soluble resin of the photosensitive resin composition. Accordingly, the issues above can be alleviated; however, the photosensitive resin composition has the disadvantage of poor alkali solution resistance.

Therefore, how to alleviate the issues of poor high precision pattern linearity and alkali solution resistance of the photosensitive resin composition at the same time so as to meet the needs of the current industry is an issue those skilled in the art urgently need to solve.

### SUMMARY OF THE INVENTION

Accordingly, the invention provides a photosensitive resin composition for a color filter of a liquid crystal display apparatus. The photosensitive resin composition can alleviate the issues of poor high precision pattern linearity and alkali solution resistance.

The invention provides a photosensitive resin composition for a color filter. The photosensitive resin composition includes a compound (A) containing an ethylenically unsaturated group, an alkali-soluble resin (B), a photoinitiator (C), a pigment (D), and an organic solvent (E). The compound (A) containing an ethylenically unsaturated group includes a first compound (A-1) containing an ethylenically unsaturated group. The first compound (A-1) containing an ethylenically unsaturated group has two or more groups represented by formula (1) and does not have an aromatic skeleton.

Specifically, the group represented by formula (1) is as follows.

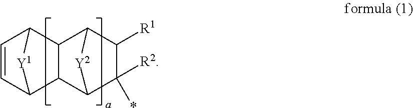

In formula (1), Y¹ and Y² each independently represent a methylene group (—CH₂), an ethylidene group

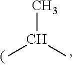

ethane-1,1-diyl), an isopropylidene group

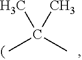

1-methylethane-1,1-diyl), an oxygen atom, or a sulfur atom; R¹ represents a hydrogen atom, an alkyl group, or a carboxyl group or a derivative group thereof; R² represents a hydrogen atom, a cyano group, an alkyl group, a substituted alkyl group, or a carboxyl group or a derivative group thereof; a represents an integer of 0 to 5; and * represents a bonding position.

In an embodiment of the invention, the first compound (A-1) containing an ethylenically unsaturated group includes a compound represented by formula (2), a compound represented by formula (3), or a combination of the two. Specifically, the compound represented by formula (2) is as follows.

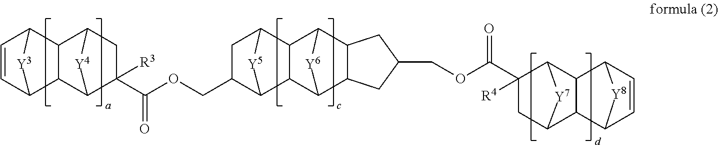

In formula (2), Y³, Y⁴, Y⁵, Y⁶, Y⁷, and Y⁸ each independently represent a methylene group, an ethylidene group, an isopropylidene group, an oxygen atom, or a sulfur atom; b, c, and d each independently represent an integer of 0 to 5; and R³ and R⁴ each independently represent a hydrogen atom or a methyl group.

Moreover, the compound represented by formula (3) is as follows.

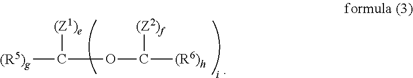

In formula (3), R⁵ and R⁶ each independently represent a C₁ to C₅ alkyl group; Z¹ and Z² each independently represent a group represented by formula (4); e represents an integer of 1 to 4; g represents an integer of 0 to 2; f and h each independently represent an integer of 0 to 3; and i represents an integer of 0 or 1. More specifically, the group represented by formula (4) is as follows.

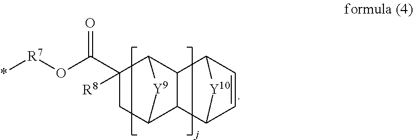

In formula (4), R⁷ represents a C₁ to C₄ alkylene group, a residue of alkylene glycol, or a residue of polyalkylene glycol; R⁸ represents a hydrogen atom or a methyl group; Y⁹ and Y¹⁰ each independently represent a methylene group, an ethylidene group, an isopropylidene group, an oxygen atom, or a sulfur atom; j represents an integer of 0 to 5; and * represents a bonding position.

In an embodiment of the invention, the alkali-soluble resin (B) includes a first alkali-soluble resin (B-1). The first alkali-soluble resin (B-1) is obtained by reacting a first mixture. The first mixture includes an epoxy compound (b-1-1) having at least two epoxy groups and a compound (b-1-2) having at least one carboxylic acid group and at least one ethylenically unsaturated group.

In an embodiment of the invention, the epoxy compound (b-1-1) having at least two epoxy groups includes a compound represented by formula (5), a compound represented by formula (6), or a combination of the two. Specifically, the compound represented by formula (5) is as follows.

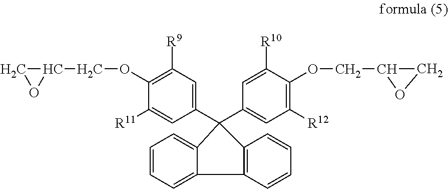

In formula (5), R⁹, R¹⁰, R¹¹, and R¹² each independently represent a hydrogen atom, a halogen atom, a C₁ to C₅ alkyl group, a C₁ to C₅ alkoxy group, a C₆ to C₁₂ aryl group, or a C₆ to C₁₂ aralkyl group.

Moreover, the compound represented by formula (6) is as follows.

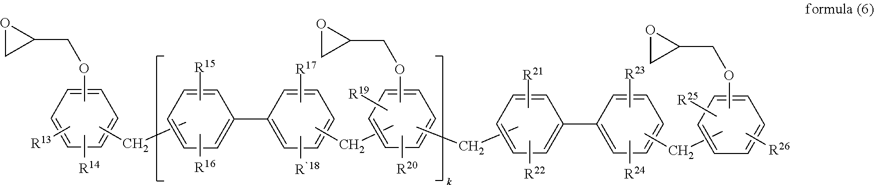

In formula (6), R¹³ to R²⁶ each independently represent a hydrogen atom, a halogen atom, a C₁ to C₈ alkyl group, or a C₆ to C₁₅ aromatic group, and k represents an integer of 0 to 10.

In an embodiment of the invention, based on a usage amount of 100 parts by weight of the alkali-soluble resin (B), the usage amount of the first alkali-soluble resin (B-1) is 3 parts by weight to 60 parts by weight.

In an embodiment of the invention, the alkali-soluble resin (B) further includes a second alkali-soluble resin (B-2). The second alkali-soluble resin (B-2) is obtained by reacting a second mixture. The second mixture includes an ethylenically unsaturated monomer (b-2-1) having at least one carboxylic acid group and other copolymerizable ethylenically unsaturated monomers (b-2-2).

In an embodiment of the invention, based on a usage amount of 100 parts by weight of the alkali-soluble resin (B), the usage amount of the second alkali-soluble resin (B-2) is 40 parts by weight to 97 parts by weight.

In an embodiment of the invention, based on a usage amount of 100 parts by weight of the alkali-soluble resin (B), the usage amount of the first compound (A-1) containing an ethylenically unsaturated group is 10 parts by weight to 100 parts by weight.

In an embodiment of the invention, based on a usage amount of 100 parts by weight of the alkai-soluble resin (B), the usage amount of the compound (A) containing an ethylenically unsaturated group is 40 parts by weight to 400 parts by weight, the usage amount of the photoinitiator (C) is 15 parts by weight to 150 parts by weight, the usage amount of the pigment (D) is 60 parts by weight to 600 parts by weight, and the usage amount of the organic solvent (E) is 500 parts by weight to 5000 parts by weight.

The invention further provides a method for manufacturing a color filter. The method includes using a pixel layer formed by the photosensitive resin composition for a color filter above.

The invention further provides a color filter. The color filter is obtained by the method above.

The invention further provides a liquid crystal display apparatus. The liquid crystal display apparatus includes the color filter above.

Based on the above, when the photosensitive resin composition of the invention is used to form a color filter, the issues of poor high precision pattern linearity and alkali solution resistance can be alleviated. As a result, the photosensitive resin composition of the invention is suitable for a color filter and a liquid crystal display apparatus.

In order to make the aforementioned features and advantages of the disclosure more comprehensible, embodiments accompanied with figures are described in detail below.

### DESCRIPTION OF THE EMBODIMENTS

### <Photosensitive Resin Composition for Color Filter>

The invention provides a photosensitive resin composition for a color filter. The photosensitive resin composition includes a compound (A) containing an ethylenically unsaturated group, an alkali-soluble resin (B), a photoinitiator (C), a pigment (D), and an organic solvent (E). Moreover, the photosensitive resin composition for a color filter can further include an additive (F) if needed.

In the following, the individual components used in the photosensitive resin composition for a color filter of the invention (also referred to as photosensitive resin composition hereinafter) are described in detail.

It should be mentioned that, in the following, (meth)acrylic acid represents acrylic acid and/or methacrylic acid, and (meth)acrylate represents acrylate and/or methacrylate. Similarly, (meth)acryloyl group represents acryloyl group and/or methacryloyl group.

### Compound (A) Containing an Ethylenically Unsaturated Group

The compound (A) containing an ethylenically unsaturated group includes a first compound (A-1) containing an ethylenically unsaturated group. Moreover, the compound (A) containing an ethylenically unsaturated group can also contain other compounds (A-2) containing an ethylenically unsaturated group other than the first compound (A-1) containing an ethylenically unsaturated group.

### First Compound (A-1) Containing an Ethylenically Unsaturated Group

The first compound (A-1) containing an ethylenically unsaturated group has two or more groups represented by formula (1) and does not have an aromatic skeleton. Specifically, the group represented by formula (1) is as follows.

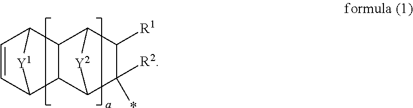

In formula (1), Y¹ and Y² each independently represent a methylene group (—CH₂), an ethylidene group

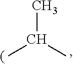

ethane-1,1-diyl), an isopropylidene group

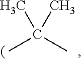

1-methylethane-1,1-diyl), an oxygen atom, or a sulfur atom; R¹ represents a hydrogen atom, an alkyl group, or a carboxyl group or a derivative group thereof; R² represents a hydrogen atom, a cyano group, an alkyl group, a substituted alkyl group, or a carboxyl group or a derivative group thereof; a represents an integer of 0 to 5; and * represents a bonding position.

In formula (1), R¹ represents a hydrogen atom, an alkyl group, or a carboxyl group or a derivative group thereof, and is preferably a hydrogen atom or a methyl group. From the perspective that less heat is needed when a synthesis is performed with a Diels-Alder reaction, R¹ preferably represents a hydrogen atom. R² represents a hydrogen atom, a cyano group, an alkyl group, a substituted alkyl group, or a carboxyl group or a derivative group thereof. Specifically, R² can represent a hydrogen atom (—H), a methyl group (—CH₃), a methylol group (—CH₂OH), a cyano group (—CN), —CH₂COOR′ (R′ is an alkyl group or an aryl group), or —COOR′ (R′ is an alkyl group or an aryl group). Preferably, at least one of R¹ and R² represents a carboxyl group. * represents a bonding position. However, a ring structure can also be formed between * and R¹.

The first compound (A-1) containing an ethylenically unsaturated group includes a compound represented by formula (2), a compound represented by formula (3), or a combination of the two. Specifically, the compound represented by formula (2) is as follows.

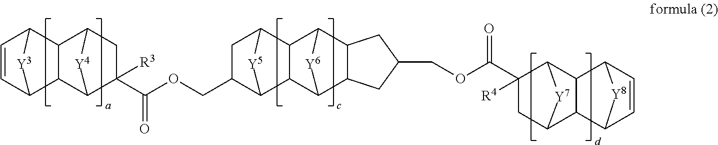

In formula (2), Y³, Y⁴, Y⁵, Y⁶, Y⁷, and Y⁸ each independently represent a methylene group, an ethylidene group, an isopropylidene group, an oxygen atom, or a sulfur atom; b, c, and d each independently represent an integer of 0 to 5; and R³ and R⁴ each independently represent a hydrogen atom or a methyl group.

Moreover, the compound represented by formula (3) is as follows.

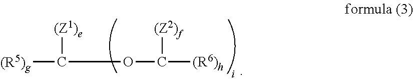

In formula (3), R⁵ and R⁶ each independently represent a C₁ to C₅ alkyl group; Z¹ and Z² each independently represent a group represented by formula (4); e represents an integer of 1 to 4; g represents an integer of 0 to 2; and f and h each independently represent an integer of 0 to 3. i represents an integer of 0 or 1.

More specifically, the group represented by formula (4) is as follows.

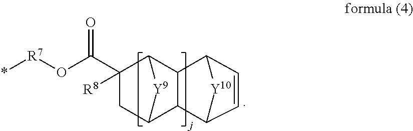

In formula (4), R⁷ represents a C₁ to C₄ alkylene group, a residue of alkylene glycol, or a residue of polyalkylene glycol; R⁸ represents a hydrogen atom or a methyl group; Y⁹ and Y¹⁰ each independently represent a methylene group, an ethylidene group, an isopropylidene group, an oxygen atom, or a sulfur atom; j represents an integer of 0 to 5; and * represents a bonding position. Moreover, in formula (3), two or more groups represented by formula (4) can exist, and the groups represented by formula (4) can be the same or each be different.

Specific examples of the compound represented by formula (3) include a compound represented by formula (3-1), a compound represented by formula (3-2), a compound represented by formula (3-3), or a compound represented by formula (3-4). Specifically, the compounds represented by formula (3-1) to formula (3-4) are as follows.

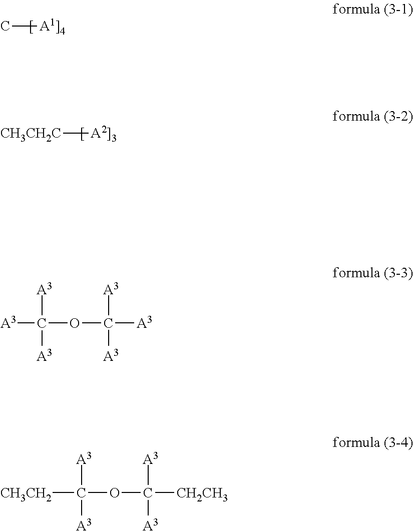

In formula (3-1) to formula (3-4), A¹, A², A³, and A⁴ are groups represented by formula (4) or C₁ to C₄ hydroxyalkyl groups. In formula (3-1) to formula (3-4), two or more groups represented by formula (4) exist.

The first compound (A-1) containing an ethylenically unsaturated group is a compound having a norbornene skeleton. Y¹ or Y² in the first compound (A-1) containing an ethylenically unsaturated group is a methylene (—CH₂—) compound and can be obtained by a method of, for instance, reacting a compound having an unsaturated double bond and a carbonyl group with cyclopentadiene. a represents an integer of 0 to 5, wherein a compound in which a is 1 or greater can be obtained by adding cyclopentadiene or a cyclic diene compound similar to cyclopentadiene in an excess amount relative to the unsaturated double bond. Moreover, when a compound in which a is 0 is synthesized, a compound in which a portion of a is not 0 may also be produced through conditions of, for instance, temperature. Specifically, the compound having an unsaturated double bond and a carbonyl group is preferably a compound having an acryloyl group and/or a methacryloyl group (hereinafter “(meth)acryloyl group”). When the compound having an unsaturated double bond and a carbonyl group is a compound having a (meth)acryloyl group, a Diels-Alder reaction readily occurs between the compound having a (meth)acryloyl group and cyclopentadiene. Moreover, a variety of products are available for (meth)acrylate having 2 or more functional groups, and from the perspective of readily available raw materials, a compound having various skeletons can be selected. Specifically, specific examples of the compound having an unsaturated double bond and a carbonyl group preferably include diacrylate of dicyclopentadiene dimethanol, pentaerythritol tetraacrylate, trimethylolpropane triacrylate, dipentaerythritol hexaacrylate, or dipentaerythritol hexamethacrylate.

Moreover, cyclopentadiene can readily be obtained by performing thermal decomposition on dicyclopentadiene. In the case that Y¹ or Y² in the first compound (A) is an oxygen atom or a sulfur atom, the compound can be obtained by respectively substituting cyclopentadiene with furan or thiophene.

Another method of synthesizing the first compound (A) containing an ethylenically unsaturated group includes reacting an acid anhydride having a norbornene skeleton with polyol. Specific examples of the acid anhydride include nadic anhydride, methyl nadic anhydride, or a combination of the acid anhydrides. Such acid anhydrides readily react with alcohol without a catalyst or when an alkaline compound is used as a catalyst. A compound having 2 or more norbornene skeletons can thus be obtained.

In addition to the synthesis method above, a plurality of synthesis methods described in Japanese Patent Publication No. 2583435 can also be used.

In the first compound (A-1) containing an ethylenically unsaturated group synthesized by a Diels-Alder reaction, specific examples of the compound having an unsaturated double bond used as one of the raw materials include esters or amides of (meth)acrylic acid, itaconic acid, crotonic acid, or maleic acid. Alternatively, the compound having an unsaturated double bond has an imide in the case that the compound is a divalent acid. In particular, from the perspective of being readily obtainable and readily performing a Diels-Alder reaction, the compound having an unsaturated double bond is preferably a compound having a (meth)acryloyl group derived from (meth)acrylic acid.

Specific examples of the compound having a (meth)acryloyl group include difunctional (meth)acrylates such as bisphenol A di(meth)acrylate, bisphenol F di(meth)acrylate, ethylene oxide (EO)-modified bisphenol A di(meth)acrylate (such as “ARONIX M210” made by Toagosei Co.), EO-modified bisphenol F di(meth)acrylate (such as “ARONIX M208” made by Toagosei Co.), propylene oxide (PO)-modified bisphenol A di(meth)acrylate (such as “light acrylate BP-4PA” made by Kyoeisha Chemical Co., Ltd.), dimethylol tricyclodecane di(meth)acrylate (such as “light acrylate DCP-A” made by Kyoeisha Chemical Co., Ltd.), hexanediol di(meth)acrylate (such as “light acrylate 1,6HX-A” made by Kyoeisha Chemical Co., Ltd.), epoxy (meth)acrylate made by reacting a bisphenol A diglycidyl ether-type epoxy resin with (meth)acrylic acid, polyethylene glycol di(meth)acrylate, polypropylene glycol di(meth)acrylate, polytetramethyleneoxide di(meth)acrylate, polyester di(meth)acrylate, or neopentyl glycol di(meth)acrylate; trifunctional (meth)acrylates such as trimethylolpropane tri(meth)acrylate, pentaerythritol tri(meth)acrylate, or tri(meth)acrylate of isocyanuric acid trihydroxyethyl (such as “ARONIX M315” made by Toagosei Co.); polyfunctional (meth)acrylates such as pentaerythritol tetra(meth)acrylate, dipentaerythritol tetra(meth)acrylate, dipentaerythritol penta(meth)acrylate, dipentaerythritol hexa(meth)acrylate, or epoxy (meth)acrylate made by reacting cresol novolac-type polyglycidylether with (meth)acrylic acid; polyfunctional acrylamides such as ethylene bisacrylamide or hexamethylene bis(meth)acrylamide; or polycyanoacrylates such as tripropyleneglycol biscyanoacrylate or 1,6-hexanediol-biscyanoacrylate. The compound having a (meth)acryloyl group can be used alone or in multiple combinations.

Specifically, the compound having an unsaturated double bond used in the synthesis of the first compound (A) containing an ethylenically unsaturated group through a Diels-Alder reaction is preferably the (meth)acrylate of a residue having a ring structure such as bisphenol, dicyclopentadiene, or isocyanuric acid, such as a polyfunctional (meth)acrylate such as pentaerythritol tri(meth)acrylate; 1,6-hexanediol di(meth)acrylate; polyethylene glycol di(meth)acrylate; or polyester di(meth)acrylate or polyurethane (meth)acrylate.

Based on a usage amount of 100 parts by weight of the alkali-soluble resin (B) described below, the usage amount of the first compound (A-1) containing an ethylenically unsaturated group can be 10 parts by weight to 100 parts by weight, preferably 12 parts by weight to 90 parts by weight, and more preferably 15 parts by weight to 80 parts by weight. When the photosensitive resin composition does not contain the first compound (A-1) containing an ethylenically unsaturated group, the alkali solution resistance of the photosensitive resin composition is poor.

### Other Compounds (A-2) Containing an Ethylenically Unsaturated Group

Other compounds (A-2) containing an ethylenically unsaturated group can be an unsaturated compound having one ethylenically unsaturated group or an unsaturated compound having two or more ethylenically unsaturated groups.

Specific examples of the compound having one ethylenically unsaturated group include acrylamide, (meth)acryloylmorpholine, 7-amino-3,7-dimethyloctyl(meth)acrylate, isobutoxymethyl(meth)acrylamide, isobornyloxyethyl(meth)acrylate, isobornyl(meth)acrylate, 2-ethylhexyl(meth)acrylate, ethyl diethylene glycol(meth)acrylate, t-octyl(meth)acryl amide, diacetone(meth)acrylamide, dim ethyl amino ethyl(meth)acrylate, dodecyl(meth)acrylate, dicyclopentenyloxyethyl(meth)acrylate, dicyclopentenyl(meth)acrylate, N,N-dimethyl(meth)acrylamide, tetrachlorophenyl(meth)acrylate, 2-tetrachlorophenoxy ethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, pentachlorophenyl(meth)acryl ate, pentabromophenyl(meth)acrylate, polyethylene glycol mono(meth)acrylate, polypropylene glycol mono(meth)acrylate, bornyl(meth)acrylate, or a combination of the compounds.

Specific examples of the unsaturated compound having two or more ethylenically unsaturated groups include ethylene glycol di(meth)acrylate, dicyclopentenyl di(meth)acrylate, triethylene glycol di acrylate, tetraethylene glycol di(meth)acrylate, tri(2-hydroxyethyl)isocyanate di(meth)acrylate, tri(2-hydroxyethyl)isocyanate tri(meth)acrylate, caprolactone-modified tri(2-hydroxyethyl)isocyanate tri(meth)acrylate, trimethylolpropyl tri(meth)acrylate, EO-modified trimethylolpropyl tri(meth)acrylate, PO-modified trimethylolpropyl tri(meth)acrylate, tripropylene glycol di(meth)acryl ate, neo-pentyl glycol di(meth)acrylate, 1,4-butanediol di(meth)acrylate, 1,6-hexanediol di(meth)acrylate, pentaerythritol tri(meth)acrylate, pentaerythritol tetra(meth)acrylate, polyester di(meth)acrylate, polyethylene glycol di(meth)acrylate, dipentaerythritol hexa(meth)acrylate (DPHA), dipentaerythritol penta(meth)acrylate, dipentaerythritol tetra(meth)acrylate, caprolactone-modified dipentaerythritol hexa(meth)acrylate, caprolactone-modified dipentaerythritol penta(meth)acrylate, di(trimethylolpropyl)tetra(meth)acrylate, EO-modified bisphenol A di(meth)acryl ate, PO-modified bisphenol A di(meth)acrylate, EO-modified hydrogenated bisphenol A di(meth)acrylate, PO-modified hydrogenated bisphenol A di(meth)acrylate, PO-modified tripropionin, EO-modified bisphenol F di(meth)acrylate, phenolic polyglycidyl ether(meth)acrylate, or a combination of the compounds.

The other compounds (A-2) containing an ethylenically unsaturated group are preferably trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, ditrimethylolpropyl tetraacrylate, or PO-modified glycerol triacrylate. The other compounds (A-2) containing an ethylenically unsaturated group can be used alone or in multiple combinations.

Based on a usage amount of 100 parts by weight of the alkali-soluble resin (B) described below, the usage amount of the other compounds (A-2) containing an ethylenically unsaturated group can be 30 parts by weight to 300 parts by weight, preferably 38 parts by weight to 260 parts by weight, and more preferably 45 parts by weight to 220 parts by weight.

Based on a usage amount of 100 parts by weight of the alkali-soluble resin (B) described below, the usage amount of the compound (A) containing an ethylenically unsaturated group can be 40 parts by weight to 400 parts by weight, preferably 50 parts by weight to 350 parts by weight, and more preferably 60 parts by weight to 300 parts by weight.

### Alkai-Soluble Resin (B)

The alkali-soluble resin (B) includes a first alkali-soluble resin (B-1), a second alkali-soluble resin (B-2), or a combination of the two.

### First Alkai-Soluble Resin (B-1)

The first alkali-soluble resin (B-1) is obtained by reacting a first mixture. The first mixture includes an epoxy compound (b-1-1) having at least two epoxy groups and a compound (b-1-2) having at least one carboxylic acid group and at least one ethylenically unsaturated group. Moreover, the first mixture can further optionally include a carboxylic acid anhydride compound (b-1-3), a compound (b-1-4) containing an epoxy group, or a combination of the two.

Epoxy Compound (b-1-1) Having at Least Two Epoxy Groups

The epoxy compound (b-1-1) having at least two epoxy groups includes a compound represented by formula (5), a compound represented by formula (6), or a combination of the two.

Specifically, the compound represented by formula (5) is as follows:

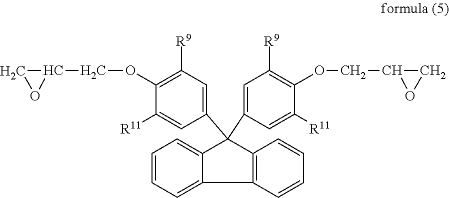

In formula (5), R⁹, R¹⁰, R¹¹, and R¹² each independently represent a hydrogen atom, a halogen atom, a C₁ to C₅ alkyl group, a C₁ to C₅ alkoxy group, a C₆ to C₁₂ aryl group, or a C₆ to C₁₂ aralkyl group.

The compound represented by formula (5) can be obtained by reacting a bisphenol fluorene-type compound with an epihalohydrin.

Specifically, specific examples of the bisphenol fluorene-type compound include: 9,9-bis(4-hydroxyphenyl)fluorene, 9,9-bis(4-hydroxy-3-methylphenyl)fluorene, 9,9-bis(4-hydroxy-3-chlorophenyl)fluorene, 9,9-bis(4-hydroxy-3-bromophenyl)fluorene, 9,9-bis(4-hydroxy-3-fluorophenyl)fluorene, 9,9-bis(4-hydroxy-3-methoxyphenyl)fluorene, 9,9-bis(4-hydroxy-3,5-dimethylphenyl)fluorene, 9,9-bis(4-hydroxy-3,5-dichlorophenyl)fluorene, 9,9-bis(4-hydroxy-3,5-dibromophenyl)fluorene, a similar compound thereof, or a combination of the compounds.

Specific examples of the epihalohydrin include epichlorohydrin, epibromohydrin, a similar compound thereof, or a combination of the compounds.

Specific examples of the bisphenol fluorene-type compound having an epoxy group include (1) products made by Nippon Steel Chemical Co., Ltd. such as ESF-300 or a similar compound thereof; (2) products made by Osaka Gas Co., Ltd. such as PG-100, EG-210, or a similar compound thereof; and (3) products made by S.M.S. Technology Co., Ltd. such as SMS-F9PhPG, SMS-F9CrG, SMS-F914PG, or a similar compound thereof.

Moreover, specifically, the compound represented by formula (6) is as follows.

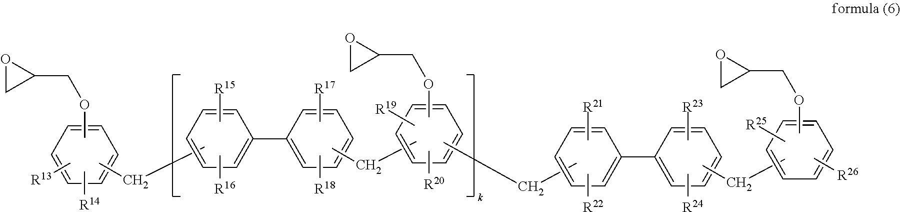

In formula (6), R¹³ to R²⁶ each independently represent a hydrogen atom, a halogen atom, a C₁ to C₈ alkyl group, or a C₆ to C₁₅ aromatic group, and k represents an integer of 0 to 10.

The compound represented by formula (6) can be obtained by reacting a compound represented by formula (6-1) and the epihalohydrin under the existence of an alkali metal hydroxide.

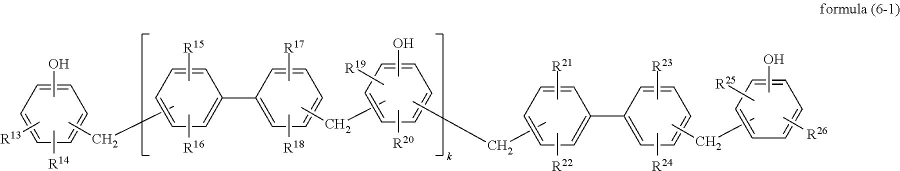

In formula (6-1), the definition of each of R¹³ to R²⁶ and k is respectively the same as the definition of each of R¹³ to R²⁶ and k in formula (6), and is not repeated herein.

The method for synthesizing the compound represented by formula (6-1) is as follows: first, a condensation reaction is performed on a compound represented by formula (6-2) and a phenol under the existence of an acid catalyst to form the compound represented by formula (6-1). Then, an excess amount of the epihalohydrin is added to perform a dehydrohalogenation reaction on the epihalohydrin and the compound represented by formula (6-1), thereby obtaining the compound represented by formula (6).

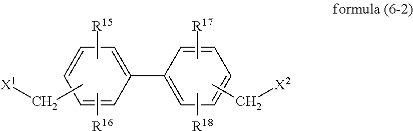

In formula (6-2), the definition of each of R¹⁵ to R¹⁸ is the same as the definition of each of R¹⁵ to R¹⁸ in formula (6), and is not repeated herein. X¹ and X² each independently represent a halogen atom, a C₁ to C₆ alkyl group, or a C₁ to C₆ alkoxy group. The halogen atom can be chlorine or bromine. The alkyl group is preferably a methyl group, an ethyl group, or t-butyl. The alkoxy group is preferably a methoxy group or an ethoxy group.

Specific examples of phenol include: phenol, cresol, ethylphenol, n-propylphenol, isobutylphenol, t-butylphenol, octylphenol, nonylphenol, xylenol, methylbutylphenol, di-t-butylphenol, vinylphenol, propenylphenol, ethinylphenol, cyclopentylphenol, cyclohexylphenol, cyclohexylcresol, or a similar compound thereof. The phenol can be used alone or in multiple combinations.

Based on a usage amount of 1 mole of the compound represented by formula (6-2), the usage amount of the phenol is 0.5 moles to 20 moles, preferably 2 moles to 15 moles.

Specific examples of the acid catalyst include: hydrochloric acid, sulfuric acid, p-toluenesulfonic acid, oxalic acid, boron trifluoride, aluminium chloride anhydrous, zinc chloride, or a similar compound thereof. The acid catalyst is preferably p-toluenesulfonic acid, sulfuric acid, hydrochloric acid, or a combination of the compounds. The acid catalyst can be used alone or in multiple combinations.

Moreover, the usage amount of the acid catalyst is not particularly limited. However, based on a usage amount of 100 wt % of the compound represented by formula (6-2), the usage amount of the acid catalyst is preferably 0.1 wt % to 30 wt %.

The condensation reaction can be performed without a solvent or under the existence of an organic solvent. Moreover, specific examples of the organic solvent include: toluene, xylene, methyl isobutyl ketone, or a similar compound thereof. The organic solvent can be used alone or in multiple combinations.

Based on a total weight of 100 wt % of the compound represented by formula (6-2) and the phenol, the usage amount of the organic solvent is 50 wt % to 300 wt %, preferably 100 wt % to 250 wt %. Moreover, the operating temperature of the condensation reaction is 40° C. to 180° C. and the operating time of the condensation reaction is 1 hour to 8 hours.

After the condensation reaction is complete, a neutralization treatment or a rinse treatment can be performed. In the neutralization treatment, the pH of the reacted solution is adjusted to pH 3 to pH 7, preferably pH 5 to pH 7. The rinse treatment can be performed by using a neutralizer, wherein the neutralizer is an alkaline substance, and specific examples thereof include: alkali metal hydroxides such as sodium hydroxide, potassium hydroxide, or a similar compound thereof; alkaline earth metal hydroxides such as calcium hydroxide, magnesium hydroxide, or a similar compound thereof; organic amines such as diethylene triamine, triethylenetetramine, aniline, phenylene diamine, or a similar compound thereof; ammonia, sodium dihydrogen phosphate, or a combination of the compounds. The neutralizer can be used alone or in multiple combinations. The rinse treatment can be performed with a known method, such as adding an aqueous solution containing a neutralizer in the reacted solution and then extracting repeatedly. After the neutralization treatment or the rinse treatment, the unreacted phenol and solvent can be distilled off by a heat treatment under reduced pressure, and then condensation is performed to obtain the compound represented by formula (6-1).

Specific examples of the epihalohydrin include: epichlorohydrin, epibromohydrin, or a combination of the compounds. Before the dehydrohalogenation reaction is performed, an alkali metal hydroxide such as sodium hydroxide or potassium hydroxide can be pre-added or added during the reaction process. The operating temperature of the dehydrohalogenation reaction is 20° C. to 120° C. and the operating time thereof ranges from 1 hour to 10 hours.

In an embodiment, the alkali metal hydroxide added in the dehydrohalogenation reaction can also be an aqueous solution thereof. In the present embodiment, when an aqueous solution of the alkali metal hydroxide is continuously added in the dehydrohalogenation reaction system, water and the epihalohydrin can be continuously distilled under reduced pressure or atmospheric pressure at the same time to separate and remove water, and the epihalohydrin can be continuously flown back into the reaction system.

Before the dehydrohalogenation reaction is performed, a quaternary ammonium salt such as tetramethyl ammonium chloride, tetramethyl ammonium bromide, trimethyl benzyl ammonium chloride, or a similar compound thereof can also be added as a catalyst, and then an alkali metal hydroxide or an aqueous solution thereof is added after the mixture is reacted for 1 hour to 5 hours at 50° C. to 150° C. Then, the mixture is reacted for 1 hour to 10 hours at a temperature of 20° C. to 120° C. to perform a dehydrohalogenation reaction.

Based on a total equivalent of 1 equivalent of the hydroxyl group in the compound represented by formula (6-1), the usage amount of the epihalohydrin is 1 equivalent to 20 equivalents, preferably 2 equivalents to 10 equivalents. Based on a total equivalent of 1 equivalent of the hydroxyl group in the compound having a structure represented by formula (6-1), the usage amount of the alkali metal hydroxide added in the dehydrohalogenation reaction is 0.8 equivalents to 15 equivalents, preferably 0.9 equivalents to 11 equivalents.

Moreover, to facilitate the dehydrohalogenation reaction, an alcohol such as methanol, ethanol, or a similar compound thereof can also be added. In addition, an aprotic polar solvent such as dimethyl sulfone, dimethyl sulfoxide, or a similar compound thereof can also be added to perform the reaction. When an alcohol is used, based on a total amount of 100 wt % of the epihalohydrin, the usage amount of the alcohol is 2 wt % to 20 wt %, preferably 4 wt % to 15 wt %. When an aprotic polar solvent is used, based on a total amount of 100 wt % of the epihalohydrin, the usage amount of the aprotic polar solvent is 5 wt % to 100 wt %, preferably 10 wt % to 90 wt %.

After the dehydrohalogenation reaction is complete, a rinse treatment can be optionally performed. Then, the epihalohydrin, the alcohol, and the aprotic polar solvent are removed by using a method of distillation under reduced pressure at, for instance, a temperature of 110° C. to 250° C. and a pressure of equal to or less than 1.3 kPa (10 mmHg).

To prevent the epoxy resin formed from containing a hydrolyzable halogen, the solution after the dehydrohalogenation reaction can be added in a solvent such as toluene or methyl isobutyl ketone and an aqueous solution of alkali metal hydroxide such as sodium hydroxide or potassium hydroxide, and then the dehydrohalogenation reaction is performed again. In the dehydrohalogenation reaction, based on a total equivalent of 1 equivalent of the hydroxyl group in the compound represented by formula (6-1), the usage amount of the alkali metal hydroxide is 0.01 moles to 0.3 moles, preferably 0.05 moles to 0.2 moles. Moreover, the range of the operating temperature of the dehydrohalogenation reaction is 50° C. to 120° C. and the range of the operating time thereof is 0.5 hours to 2 hours.

After the dehydrohalogenation reaction is complete, the salt is removed through steps such as filtering and rinsing. Moreover, a method of distillation under reduced pressure is used to remove solvents such as toluene and methyl isobutyl ketone so as to obtain the compound represented by formula (6). Specific examples of the compound represented by formula (6) include products such as NC-3000, NC-3000H, NC-3000S, or NC-3000P made by Nippon Kayaku Co., Ltd.

Compound (b-1-2) Having at Least One Carboxylic Acid Group and at Least One Ethylenically Unsaturated Group

Specific examples of the compound (b-1-2) having at least one carboxylic acid group and at least one ethylenically unsaturated group are selected from the group consisting of the following (1) to (3): (1) acrylic acid, methacrylic acid, 2-methacryloyloxyethylbutanedioic acid, 2-methacryloyloxybutylbutanedioic acid, 2-methacryloyloxyethylhexanedioic acid, 2-methacryloyloxybutylhexanedioic acid, 2-methacryloyloxyethylhexahydrophthalic acid, 2-methacryloyloxyethylmaleic acid, 2-methacryloyloxypropylmaleic acid, 2-methacryloyloxybutylmaleic acid, 2-methacryloyloxypropylbutanedioic acid, 2-methacryloyloxypropylhexanedioic acid, 2-methacryloyloxypropyltetrahydrophthalic acid, 2-methacryloyloxypropylphthalic acid, 2-methacryloyloxybutylphthalic acid, or 2-methacryloyloxybutylhydrophthalic acid; (2) a compound obtained by reacting (meth)acrylate containing a hydroxyl group with a dicarboxylic acid compound, wherein the dicarboxylic acid compound includes adipic acid, succinic acid, maleic acid, or phthalic acid; or (3) a hemiester compound obtained by reacting (meth)acrylate containing a hydroxyl group with the carboxylic acid anhydride compound (b-1-3) above, wherein the (meth)acrylate containing a hydroxyl group includes (2-hydroxyethyl)acrylate, (2-hydroxyethyl)methacrylate, (2-hydroxypropyl)acrylate, (2-hydroxypropyl)methacrylate, (4-hydroxybutyl)acrylate, (4-hydroxybutyl)methacrylate, or pentaerythritol trimethacrylate. Moreover, the carboxylic acid anhydride compound here can be the same as the carboxylic acid anhydride compound (b-1-3) contained in the first mixture of the first alkali-soluble resin (B-1) above.

Carboxylic Acid Anhydride Compound (b-1-3)

The carboxylic acid anhydride compound (b-1-3) can be selected from the group consisting of the following (1) to (2): (1) a dicarboxylic acid anhydride compound such as butanedioic anhydride, maleic anhydride, itaconic anhydride, phthalic anhydride, tetrahydrophthalic anhydride, hexahydrophthalic anhydride, methyl tetrahydrophthalic anhydride, methyl hexahydrophthalic anhydride, methyl endo-methylene tetrahydro phthalic anhydride, chlorendic anhydride, glutaric anhydride, or 1,3-dioxoisobenzofuran-5-carboxylic anhydride; and (2) a tetracarboxylic acid anhydride compound such as benzophenone tetracarboxylic dianhydride (BTDA), biphenyl tetracarboxylic dianhydride, or biphenyl ether tetracarboxylic dianhydride.

Compound (b-1-4) Containing an Epoxy Group

The compound (b-1-4) containing an epoxy group can be selected from glycidyl methacrylate, 3,4-epoxycyclohexylmethacrylate, a glycidyl ether compound containing an unsaturated group, an unsaturated compound containing an epoxy group, or a combination of the compounds. The glycidyl ether compound containing an unsaturated group includes products made by Nagase Kasei Kogyo Co., Ltd. such as Denacol EX-111, Denacol EX-121, Denacol EX-141, Denacol EX-145, Denacol EX-146, Denacol EX-171, or Denacol EX-192.

The first alkali-soluble resin (B-1) can be a reaction product containing a hydroxyl group formed by performing a polymerization reaction on the epoxy compound (b-1-1) having at least two epoxy groups and the compound (b-1-2) having at least one carboxylic acid group and at least one ethylenically unsaturated group. In particular, the epoxy compound (b-1-1) having at least two epoxy groups is a compound represented by formula (6). Then, the carboxylic acid anhydride compound (b-1-3) is added to the reaction solution to perform a polymerization reaction. Based on a total equivalent of 1 equivalent of the hydroxyl group of the reaction product containing a hydroxyl group, the equivalent of the acid anhydride group contained in the carboxylic acid anhydride compound (b-1-3) is preferably 0.4 equivalents to 1 equivalent, more preferably 0.75 equivalents to 1 equivalent. When a plurality of the carboxylic acid anhydride compounds (b-1-3) are used, the carboxylic acid anhydride compounds can be added to the reaction in sequence or at the same time. When a dicarboxylic acid anhydride compound and a tetracarboxylic acid anhydride compound are used as the carboxylic acid anhydride compound (b-1-3), the molar ratio of the dicarboxylic acid anhydride compound and the tetracarboxylic acid anhydride compound is preferably 1/99 to 90/10, more preferably 5/95 to 80/20. Moreover, the operating temperature of the reaction can be 50° C. to 130° C.

The first alkali-soluble resin (B-1) can be a reaction product containing a hydroxyl group formed by reacting the epoxy compound (b-1-1) having at least two epoxy groups with the compound (b-1-2) having at least one carboxylic acid group and at least one ethylenically unsaturated group. In particular, the epoxy compound (b-1-1) having at least two epoxy groups is a compound represented by formula (6). Then, the carboxylic acid anhydride compound (b-1-3), the compound (b-1-4) containing an epoxy group, or a combination of the two is added to the reaction solution to perform a polymerization reaction. Based on a total equivalent of 1 equivalent of the epoxy groups in the compound represented by formula (6), the acid value equivalent of the compound (b-1-2) having at least one carboxylic acid group and at least one ethylenically unsaturated group is preferably 0.8 equivalents to 1.5 equivalents, more preferably 0.9 equivalents to 1.1 equivalents. Based on a total usage amount of 100 mole % of the hydroxyl group of the reaction product containing a hydroxyl group, the usage amount of the carboxylic acid anhydride compound (b-1-3) is 10 mole % to 100 mole %, preferably 20 mole % to 100 mole %, and more preferably 30 mole % to 100 mole %.

When preparing the first alkali-soluble resin (B-1), to reduce reaction time, an alkaline compound is generally added to the reaction solution as a reaction catalyst. The reaction catalyst includes, for instance, triphenyl phosphine, triphenyl stibine, triethylamine, triethanolamine, tetramethylammonium chloride, or benzyltriethylammonium chloride. The acid catalyst can be used alone or in multiple combinations.

Based on a total usage amount of 100 parts by weight of the epoxy compound (b-1-1) having at least two epoxy groups and the compound (b-1-2) having at least one carboxylic acid group and at least one ethylenically unsaturated group, the usage amount of the reaction catalyst is preferably 0.01 parts by weight to 10 parts by weight, more preferably 0.3 parts by weight to 5 parts by weight.

Moreover, to control the degree of polymerization, a polymerization inhibitor can be added to the reaction solution. The polymerization inhibitor includes, for instance, methoxyphenol, methylhydroquinone, hydroquinone, 2,6-di-t-butyl-p-cresol, or phenothiazine. The polymerization inhibitor can be used alone or in multiple combinations.

Based on a total usage amount of 100 parts by weight of the epoxy compound (b-1-1) having at least two epoxy groups and the compound (b-1-2) having at least one carboxylic acid group and at least one ethylenically unsaturated group, the usage amount of the polymerization inhibitor is preferably 0.01 parts by weight to 10 parts by weight and more preferably 0.1 parts by weight to 5 parts by weight.

When preparing the first alkali-soluble resin (B-1), a polymerization solvent can optionally be used. The polymerization solvent includes an alcohol solvent such as ethanol, propanol, isopropanol, butanol, isobutanol, 2-butanol, hexanol, or ethylene glycol; a ketone solvent such as methyl ethyl ketone or cyclohexanone; an aromatic hydrocarbon solvent such as toluene or xylene; a cellosolve solvent such as cellosolve or butyl cellosolve; a carbitol solvent such as carbitol or butyl carbitol; a propylene glycol alkyl ether solvent such as propylene glycol monomethyl ether; a poly(propylene glycol) alkyl ether solvent such as di(propylene glycol) methyl ether; an acetate solvent such as ethyl acetate, butyl acetate, ethylene glycol monoethyl ether acetate, or propylene glycol methyl ether acetate; an alkyl lactate solvent such as ethyl lactate or butyl lactate; or a dialkyl glycol ether solvent. The polymerization solvent can be used alone or in multiple combinations. Moreover, the acid value of the first alkali-soluble resin (B-1) is preferably 50 mgKOH/g to 200 mgKOH/g, more preferably 60 mgKOH/g to 150 mgKOH/g.

Based on a usage amount of 100 parts by weight of the alkai-soluble resin (B), the usage amount of the first alkali-soluble resin (B-1) can be 3 parts by weight to 60 parts by weight, preferably 4 parts by weight to 50 parts by weight, and more preferably 5 parts by weight to 40 parts by weight. When the alkali-soluble resin (B) contains the first alkali-soluble resin (B-1), the obtained photosensitive resin composition has high precision pattern linearity.

### Second Alkai-Soluble Resin (B-2)

The second alkali-soluble resin (B-2) is formed by copolymerizing an ethylenically unsaturated monomer (b-2-1) having at least one carboxylic acid group and other copolymerizable ethylenically unsaturated monomers (b-2-2), wherein the total usage amount of the ethylenically unsaturated monomer (b-2-1) having at least one carboxylic acid group and the other copolymerizable ethylenically unsaturated monomers (b-2-2) is 100 parts by weight.

Specific examples of the ethylenically unsaturated monomer (b-2-1) having at least one carboxylic acid group include an unsaturated monocarboxylic acid compound such as an acrylic acid, methacrylic acid, butenoic acid, α-chloroacrylic acid, ethyl acrylic acid, cinnamic acid, 2-acryloyloxyethyl succinate, or 2-methacryloyloxyethyl succinate monoester; an unsaturated dicarboxylic acid (anhydride) compound such as maleic acid, maleic anhydride, fumaric acid, itaconic acid, itaconic anhydride, citraconic acid, or citraconic anhydride; or a trivalent or more unsaturated polycarboxylic acid (anhydride) compound. The ethylenically unsaturated monomer (b-2-1) having at least one carboxylic acid group can be used alone or in multiple combinations.

The ethylenically unsaturated monomer (b-2-1) having at least one carboxylic acid group is preferably acrylic acid, methacrylic acid, 2-acryloyloxyethyl succinate, 2-methacryloyloxyethyl succinate monoester, or a combination of the compounds.

Specific examples of the other copolymerizable ethylenically unsaturated monomers (b-2-2) include aromatic vinyl compounds such as dicyclopentanyl acrylate, dicyclopentanyl ethoxy acrylate, dicyclopentenyl acrylate (hereinafter FA-511A), dicyclopentenyloxyethyl acrylate (hereinafter FA-512A), dicyclopentanyl methacrylate, dicyclopentanyloxyethyl methacrylate, dicyclopentenyl methacrylate, dicyclopentenyloxyethyl methacrylate, styrene, α-methylstyrene, vinyltoulene, chlorostyrene, or methoxystyrene; meleimide compounds such as N-phenylmaleimide, N-o-hydroxyphenyl maleimide, N-m-hydroxyphenyl maleimide, N-p-hydroxyphenyl maleimide, N-o-methylphenyl maleimide, N-m-methylphenyl maleimide, N-p-methylphenyl maleimide, N-o-methoxyphenyl maleimide, N-m-methoxyphenyl maleimide, N-p-methoxyphenyl maleimide, or N-cyclohexylmaleimide; unsaturated carboxylic acid ester compounds such as methyl acrylate, methyl methacrylate, benzyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, iso-butyl acrylate, iso-butyl methacrylate, sec-butyl acrylate, sec-butyl methacrylate, t-butyl acrylate, t-butyl methacrylate, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, phenyl acrylate, phenyl methacrylate, methoxy triethylene glycol acrylate, methoxy triethylene glycol methacrylate, lauryl methacrylate, tetradecyl methacrylate, cetyl methacrylate, octadecyl methacrylate, eicosyl methacrylate, or docosyl methacrylate; ethyl N,N-dimethylamino acrylate, ethyl N,N-dimethylamino methacrylate, propyl N,N-diethylamino acrylate, propyl N,N-dimethylamino methacrylate, propyl N,N-dibutylamino acrylate, or ethyl N-isobutylamino methacrylate; unsaturated carboxylic acid epoxypropyl ester compounds such as epoxypropyl acrylate or epoxypropyl methacrylate; carboxylic acid vinyl ester compounds such as vinyl acetate, vinyl propionate, or vinyl butyrate; unsaturated ether compounds such as methyl vinyl ether, ethyl vinyl ether, allyl glycidyl ether, or methallyl glycidyl ether; vinyl cyanide compounds such as acrylonitrile, methacrylonitrile, α-chloroacrylonitrile, or vinylidene cyanide; unsaturated amide compounds such as acrylamide, methacrylamide, α-chloro acrylamide, N-hydroxyethyl acrylamide, or N-hydroxyethyl methacrylamide; aliphatic conjugated diene compounds such as 1,3-butadiene, isoamylene, or chlorinated butadiene, or a combination of the compounds. The specific examples of the other copolymerizable ethylenically unsaturated monomers (b-2-2) can be used alone or in multiple combinations.

The other copolymerizable ethylenically unsaturated monomers (b-2-2) are preferably selected from the group consisting of dicyclopentanyl acrylate, dicyclopentanyloxyethyl acrylate, dicyclopentenyl acrylate, dicyclopentenyloxyethyl acrylate, dicyclopentanyl methacrylate, dicyclopentanyloxyethyl methacrylate, dicyclopentenyl methacrylate, dicyclopentenyloxyethyl methacrylate, styrene, N-phenyl maleimide, methyl acrylate, methyl methacrylate, 2-hydroxyethyl acrylate, 2-hydroxyethyl methacrylate, benzyl acrylate, and benzyl methacrylate.

The solvent used to prepare the second alkali-soluble resin (B-2) includes alkylene glycol monoalkyl ether or polyalkylene glycol monoalkyl ether solvents such as ethylene glycol monomethyl ether, ethylene glycol monoethyl ether, diethylene glycol monomethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, dipropylene glycol monomethyl ether, dipropylene glycol monoethyl ether, dipropylene glycol mono-n-propyl ether, dipropylene glycol mono-n-butyl ether, tripropylene glycol monomethyl ether, or tripropylene glycol monoethyl ether; (poly)alkylene glycol monoalkyl ether acetate or polyalkylene glycol monoalkyl ether acetate solvents such as ethylene glycol monomethyl ether acetate, ethylene glycol monoethyl ether acetate, propylene glycol monomethyl ether acetate, or propylene glycol monoethyl ether acetate; other ether solvents such as diethylene glycol dimethyl ether, diethylene glycol methyl ethyl ether, diethylene glycol diethyl ether, or tetrahydrofuran; ketone solvents such as methyl ethyl ketone, cyclohexanone, 2-heptanone, or 3-heptanone; alkyl lactate solvents such as methyl 2-hydroxypropanoate or ethyl 2-hydroxypropanoate; other ester solvents such as methyl 2-hydroxy-2-methylpropanoate, ethyl 2-hydroxy-2-methylpropanoate, methyl 3-methoxypropanoate, ethyl 3-methoxypropanoate, methyl 3-ethoxypropanoate, ethyl 3-ethoxypropanoate (EEP), ethyl ethoxyacetate, ethyl hydroxyacetate, methyl 2-hydroxy-3-methylenebutyrate, 3-methyl-3-methoxybutyl acetate, 3-methyl-3-methoxybutyl propanoate, ethyl acetate, n-propyl acetate, isopropyl acetate, n-butyl acetate, isobutyl acetate, n-amyl acetate, isoamyl acetate, n-butyl propanoate, ethyl butyrate, n-propyl butyrate, isopropyl butyrate, n-butyl butyrate, methyl pyruvate, ethyl pyruvate, n-propyl pyruvate, methyl acetoacetate, ethyl acetoacetate, or ethyl 2-oxybutyrate; aromatic hydrocarbon solvents such as toluene or xylene; or carboxylic amine solvents such as N-methylpyrrolidone, N,N-dimethylformamide, or N,N-dimethylacetamide. The solvent can be used alone or in multiple combinations.

The solvent for preparing the second alkali-soluble resin (B-2) is preferably propylene glycol monomethyl ether acetate, EEP, or a combination of the two.

The initiator used to prepare the second alkali-soluble resin (B-2) is generally a free radical-type polymerization initiator. The free radical-type polymerization initiator includes azo compounds such as 2,2′-azobisisobutyronitrile, 2,2′-azobis-(2,4-dimethylvaleronitrile), 2,2′-azobis-(4-methoxy-2,4-dimethylvaleronitrile), or 2,2′-azobis-2-methyl butyronitrile; peroxide compounds such as benzoylperoxide, or a combination of the compounds.

Based on a usage amount of 100 parts by weight of the alkai-soluble resin (B), the usage amount of the second alkali-soluble resin (B-2) can be 40 parts by weight to 97 parts by weight, preferably 50 parts by weight to 96 parts by weight, and more preferably 60 parts by weight to 95 parts by weight. When the alkali-soluble resin (B) contains the second alkali-soluble resin (B-2), the obtained photosensitive resin composition has high precision pattern linearity. It should be mentioned that, when the alkali-soluble resin (B) contains the first alkali-soluble resin (B-1) and the second alkali-soluble resin (B-2) at the same time, the obtained photosensitive resin composition has better high precision pattern linearity.

### Photoinitiator (C)

The photoinitiator (C) can be a free radical-type photoinitiator. Specifically, the photoinitiator (C) is, for instance, an oxime compound, a triazine compound, an acetophenone compound, a biimidazole compound, or a benzophenone compound.

Specific examples of the 0-oxime compound include 1[4-(phenylthio)phenyl]-heptane-1,2-dione-2-(O-benzoyloxime), 1-[4-(phenylthio)phenyl]-octane-1,2-dione-2-(O-benzoyloxime), 1-[4-(benzoyl)phenyl]-octane-1,2-dione-2-(O-benzoyloxime), 1-[9-ethyl-6-(2-methylbenzoyl)-9H-carbazol-3-yl]-ethanone-1-(O-acetyloxime), 1-[9-ethyl-6-(3-methylbenzoyl)-9H-carbazol-3-yl]-ethanone-1-(O-acetyloxime), 1-[9-ethyl-6-benzoyl-9H-carbazol-3-yl]-ethanone-1-(O-acetyloxime), ethanone-1-[9-ethyl-6-(2-methyl-4-tetrahydrofuranbenzoyl)-9H-carbazol-3-yl]-1-(O-acetyloxime), ethanone-1-[9-ethyl-6-(2-methyl-5-tetrahydrofuranbenzoyl)-9H-carbazol-3-yl]-1-(O-acetyloxime), ethanone-1-[9-ethyl-6-(2-methyl-4-tetrahydrofuranmethoxybenzoyl)-9H-carbazol-3-yl]-1-(O-acetyloxime), ethanone-1-[9-ethyl-6-(2-methyl-5-tetrahydrofuranmethoxybenzoyl)-9H-carbazol-3-yl]-1-(O-acetyloxime), ethanone-1-[9-ethyl-6-{2-methyl-4-(2,2-dimethyl-1,3-dioxolan)benzoyl}-9H-carbazol-3-yl]-1-(O-acetyloxime), ethanone-1-[9-ethyl-6-{2-methyl-4-(2,2-dimethyl-1,3-dioxolan)methoxybenzoyl}-9H-carbazol-3-yl]-1-(O-acetyloxime), or a combination of the compounds.

Specific examples of the triazine compound include 2,4-bis(trichloromethyl)-6-(p-methoxy)styryl-s-triazine, 2,4-bis(trichloromethyl)-6-(1-p-dimethylaminophenyl-1,3-butadienyl), 2-trichloromethyl-4-amino-6-(p-methoxy)styryl-s-triazine, or a combination of the compounds.

Specific examples of the acetophenone compound include p-dimethylamino-acetophenone, α,α′-dimethoxyazoxy-acetophenone, 2,2′-dimethyl-2-phenyl-acetophenone, p-methoxy-acetophenone, 2-methyl-1-(4-methylthiophenyl)-2-morpholino-1-propanone, 2-benzyl-2-N,N-dimethylamino-1-(4-morpholinophenyl)-1-butanone, or a combination of the compounds.

Specific examples of the biimidazole compound include 2,2′-bis(o-chlorophenyl)-4,4′,5,5′-tetraphenyl-biimidazole, 2,2′-bis(o-fluorophenyl)-4,4′,5,5′-tetraphenyl-biimidazole, 2,2′-bis(o-methylphenyl)-4,4′,5,5′-tetraphenyl-biimidazole, 2,2′-bis(o-methoxyphenyl)-4,4′,5,5′-tetraphenyl-biimidazole, 2,2′-bis(o-ethylphenyl)-4,4′,5,5′-tetraphenyl-biimidazole, 2,2′-bis(p-methoxyphenyl)-4,4′,5,5′-tetraphenyl-biimidazole, 2,2′-bis(2,2′,4,4′-tetramethoxyphenyl)-4,4′,5,5′-tetraphenyl-biimidazole, 2,2′-bis(2-chlorophenyl)-4,4′,5,5′-tetraphenyl-biimidazole, or 2,2′-bis(2,4-dichlorophenyl)-4,4′,5,5′-tetraphenyl-biimidazole, or a combination of the compounds.

Specific examples of the benzophenone compound include thioxanthone, 2,4-diethylthioxanthone, thioxanthone-4-sulfone, benzophenone, 4,4′-bis(dimethylamino)benzophenone, or 4,4′-bis(diethylamino)benzophenone, or a combination of the compounds.

The photoinitiator (C) is preferably 2-methyl-1-(4-methylthiophenyl)-2-morpholino-1-propanone, 1-[4-(phenylthio)phenyl]-octane-1,2-dione-2-(O-benzoyloxime), 1-[9-ethyl-6-(2-methylbenzoyl)-9H-carbazol-3-yl]-ethanone-1-(O-acetyloxime), ethanone-1-[9-ethyl-6-(2-methyl-4-(tetrahydrofuran)methoxybenzoyl)-9H-carbazol-3-yl]-1-(O-acetyloxime), ethanone-1-[9-ethyl-6-{2-methyl-4-(2,2-dimethyl-1,3-dioxolan)methoxybenzoyl}-9H-carbazol-3-yl]-1-(O-acetyloxime), 2,4-bis(trichloromethyl)-6-(p-methoxy)styryl-s-triazine, 2-benzyl-2-N,N-dimethylamino-1-(4-morpholinophenyl)-1-butanone, 2,2′-bis(2,4-dichlorophenyl)-4,4′,5,5′-tetraphenyl-1,2′-biimidazole, 4,4′-bis(diethylamino)benzophenone, or a combination of the compounds.

The photoinitiator (C) can be used alone or in multiple combinations.

Moreover, without affecting the physical properties, an initiator other than the photoinitiator (C) can be further added to the photosensitive resin composition of the invention according to need. The initiator includes, for instance, an α-diketone compound, an acyloin compound, an acyloin ether compound, an acylphosphineoxide compound, a quinone compound, a halogen-containing compound, or peroxide.

Specific examples of the α-diketone compound include benzil compounds or acetyl compounds, or a combination of the compounds.

Specific examples of the acyloin compound include benzoin or a combination of the compounds.

Specific examples of the ether ketone compound include benzoin methylether, benzoin ethylether, benzoin isopropyl ether, or a combination of the compounds.

Specific examples of the acylphosphine oxide compound include 2,4,6-trimethyl-benzoyl diphenylphosphineoxide, bis-(2,6-dimethoxy-benzoyl)-2,4,4-trimethylbenzyl phosphineoxide, or a combination of the compounds.

Specific examples of the quinone compound include anthraquinone, 1,4-naphthoquinone, or a combination of the compounds.

Specific examples of the halogen-containing compound include phenacyl chloride, tribromomethyl phenylsulfone, tris(trichloromethyl)-s-triazine, or a combination of the compounds.

Specific examples of the peroxide include di-tertbutylperoxide or a combination of the compounds.

The photoinitiator (C) can be used alone or in multiple combinations.

When the photoinitiator (C) is not used, the alkali solution resistance of the photosensitive resin composition is poor.

Based on a usage amount of 100 parts by weight of the alkali-soluble resin (B), the usage amount of the photoinitiator (C) can be 15 parts by weight to 150 parts by weight, preferably 20 parts by weight to 120 parts by weight, and more preferably 25 parts by weight to 90 parts by weight.

### Pigment (D)

The pigment (D) can be an inorganic pigment, an organic pigment, or a mixture thereof. The inorganic pigment can be a metal compound such as metal oxide or a metallic complex salt, and specific examples thereof include metal oxides such as iron, cobalt, aluminum, cadmium, lead, copper, titanium, magnesium, chromium, zinc, or antimony, or composite oxides of the metals thereof.

Specific examples of the organic pigment include, for instance, C. I. pigment yellow 1, 3, 11, 12, 13, 14, 15, 16, 17, 20, 24, 31, 53, 55, 60, 61, 65, 71, 73, 74, 81, 83, 93, 95, 97, 98, 99, 100, 101, 104, 106, 108, 109, 110, 113, 114, 116, 117, 119, 120, 126, 127, 128, 129, 138, 139, 150, 151, 152, 153, 154, 155, 156, 166, 167, 168, 175; C. I. pigment orange 1, 5, 13, 14, 16, 17, 24, 34, 36, 38, 40, 43, 46, 49, 51, 61, 63, 64, 71, 73; C. I. pigment red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48:1, 48:2, 48:3, 48:4, 49:1, 49:2, 50:1, 52:1, 53:1, 57, 57:1, 57:2, 58:2, 58:4, 60:1, 63:1, 63:2, 64:1, 81:1, 83, 88, 90:1, 97, 101, 102, 104, 105, 106, 108, 112, 113, 114, 122, 123, 144, 146, 149, 150, 151, 155, 166, 168, 170, 171, 172, 174, 175, 176, 177, 178, 179, 180, 185, 187, 188, 190, 193, 194, 202, 206, 207, 208, 209, 215, 216, 220, 224, 226, 242, 243, 245, 254, 255, 264, 265; C. I. pigment violet 1, 19, 23, 29, 32, 36, 38, 39; C. I. pigment blue 1, 2, 15, 15:3, 15:4, 15:6, 16, 22, 60, 66; C. I. pigment green 7, 36, 37; C. I. pigment brown 23, 25, 28, or C. I. pigment black 1, 7. The pigment (D) can be used alone or in multiple combinations.

In the photosensitive resin composition for a color filter, the average particle diameter of the pigment (D) is generally 10 nm to 200 nm, preferably 20 nm to 150 nm, and more preferably 30 nm to 130 nm.

Depending on actual need, the pigment (D) can be used with a dispersant such as a cationic surfactant, an anionic surfactant, a nonionic surfactant, a zwitterionic surfactant, a polysiloxane surfactant, a fluorosurfactant, or a combination of the dispersants.

Specific examples of the surfactant include, for instance, polyoxyethylene alkyl ether such as polyoxyethylene lauryl ether, polyoxyethylene stearyl ether, or polyoxyethylene oleyl ether; polyoxyethylene alkyl phenyl ether such as polyoxyethylene octyl phenyl ether or polyoxyethylene nonyl phenyl ether; polyethylene glycol dialkyl ester such as polyethylene glycol dilaurate or polyethylene glycol distearate; sorbitan fatty acid ester; fatty acid-modified polyester; tertiary amine-modified polyurethane; or KP made by Shin-Etsu Chemical Co., Ltd., SF-8427 made by Dow Corning Toray Co., Ltd., Polyflow made by Kyoei-Sha Yushi Kagaku Kogyo Co., Ltd., F-Top made by Tochem Products Co., Ltd., Megafac made by Dainippon Ink & Chemicals, Inc., Fluorade made by Sumitomo 3M Co., Ltd., Asahi Guard made by Asahi Glass, or Surflon made by Asahi Glass Co., Ltd.

Based on a usage amount of 100 parts by weight of the alkali-soluble resin (B), the usage amount of the pigment (D) can be 60 parts by weight to 600 parts by weight, preferably 80 parts by weight to 500 parts by weight, and more preferably 100 parts by weight to 400 parts by weight.

### Organic Solvent (E)

The organic solvent (E) refers to a solvent capable of dissolving the compound (A) containing an ethylenically unsaturated group, the alkali-soluble resin (B), the photoinitiator (C), and the pigment (D), but does not react with the components, and preferably has a suitable volatility.

Moreover, the organic solvent (E) can be the same as the organic solvent used in the preparation of the second alkali-soluble resin (B-2) and is not repeated herein. The organic solvent (E) is preferably propylene glycol monomethyl ether acetate, EEP, or a combination of the solvents.

Based on a usage amount of 100 parts by weight of the alkali-soluble resin (B), the usage amount of the organic solvent (E) can be 500 parts by weight to 5000 parts by weight, preferably 800 parts by weight to 4500 parts by weight, and more preferably 1000 parts by weight to 4000 parts by weight.

### Additive (F)

Under the premise of not affecting the efficacy of the invention, the photosensitive resin composition of the invention can optionally further include an additive (F). Specific examples of the additive (F) include a filler, a polymer (other than the alkali-soluble resin (B)), an adhesion promoting agent, an antioxidant, an ultraviolet absorber, an anti-coagulant, or a combination of the additives.

Specific examples of the filler include, for instance, glass or aluminum.

Specific examples of the polymer include polyvinyl alcohol, polyethylene glycol monoalkyl ether, polyfluoro alkyl acrylate, or a combination of the polymers.

Specific examples of the adhesion promoting agent include vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidyloxy propyltrimethoxysilane, 3-glycidyloxy propylmethyldimethoxysilane, 2-(3,4-epoxycyclohexyl)ethyltrimethoxysilane, 3-chloropropylmethyl dimethoxysilane, 3-chloropropyltrimethoxysilane, 3-methacryloyloxypropyltrimethoxysilane, 3-mercaptopropyltrimethoxysilane, or a combination of the compounds.

Specific examples of the antioxidant include 2,2-thiobis(4-methyl-6-t-butylphenol), 2,6-di-t-butylphenol, or a combination of the compounds.

Specific examples of the ultraviolet absorber include 2-(3-t-butyl-5-methyl-2-hydroxyphenyl)-5-chlorophenylazide, alkoxy phenone, or a combination of the compounds.

Specific examples of the anti-coagulant include, for instance, sodium polyacrylate.

Based on a usage amount of 100 parts by weight of the alkali-soluble resin (B), the usage amount of the additive (F) can be 0.01 part by weight to 5 parts by weight, preferably 0.05 parts by weight to 4 parts by weight, and more preferably 0.1 parts by weight to 3 parts by weight.

### <Method for Preparing Photosensitive Resin Composition for Color Filter>

A method that can be used to prepare the photosensitive resin composition includes, for instance: placing and stirring the compound (A) containing an ethylenically unsaturated group, the alkai-soluble resin (B), the photoinitiator (C), the pigment (D), and the organic solvent (E) in a stirrer such that the compositions are uniformly mixed into a solution state. When needed, the additive (F) can also be added. After the compositions are uniformly mixed, the photosensitive resin composition in a solution state can be obtained.

In addition, the method for preparing the photosensitive resin composition is not particularly limited. The method for preparing the photosensitive resin composition includes, for instance, first dispersing a portion of the alkali-soluble resin (B) and the compound (A) containing an ethylenically unsaturated group in a portion of the organic solvent (E) to form a dispersion solution, and then mixing the rest of the pigment (D), the compound (A) containing an ethylenically unsaturated group, the alkali-soluble resin (B), the photoinitiator (C), and the organic solvent (E).

Alternatively, the photosensitive resin composition can also be prepared by first dispersing a portion of the pigment (D) in a portion of the organic solvent (E) to form a pigment dispersion solution, and then mixing the rest of the pigment (D), the compound (A) containing an ethylenically unsaturated group, the alkali-soluble resin (B), the photoinitiator (C), and the rest of the organic solvent (E). Moreover, the dispersion steps of the pigment (D) can be performed by, for instance, mixing with a mixer such as a beads mill or a roll mill.

### <Method for Preparing Pixel Layer and Color Filter>

The color filter is obtained by applying the treatments of pre-bake, exposure, development, and post-bake to a substrate with a black matrix formed thereon with the photosensitive resin composition for a color filter in sequence, wherein the black matrix is used to isolate each pixel layer (the pixel layer is also referred to as a pixel color layer in the following). The method for preparing the color filter is described below.

First, the photosensitive resin composition in a solution state for a color filter is uniformly coated on a substrate by a coating method such as spin coating, cast coating, or roll coating to form a coating film. The substrate is, for instance, a glass for a liquid crystal display apparatus such as alkali-free glass, soda-lime glass, hard glass (Pyrex glass), quartz glass, or such glass attached with a transparent conductive film; a substrate (such as a silicon substrate) for a photoelectric conversion apparatus (such as a solid-state imaging apparatus); or a substrate with a shading black matrix capable of isolating, for instance, red, green, and blue pixel color layers formed thereon.

After the coating layer is formed, most of the solvent is removed by a method of drying under reduced pressure. Next, the remaining solvent is completely removed by a pre-bake method to form a pre-baked coating film. It should be mentioned that, the conditions for drying under reduced pressure and pre-bake vary according to the type and the ratio of each component. Generally, drying under reduced pressure is performed at a pressure of 0 mmHg to 200 mmHg for 1 second to 60 seconds, and the pre-bake is a heat treatment performed on the coating film at a temperature of 70° C. to 110° C. for 1 minute to 15 minutes.

Then, the pre-baked coating film is exposed with a photomask having a specific pattern. The light used in the exposure process is preferably an ultraviolet such as a g-ray, an h-ray, or an i-ray. In addition, the ultraviolet irradiation apparatus can be a(n) (ultra-)high pressure mercury lamp or a metal halide lamp.

Then, the exposed pre-baked coating film is immersed in a developing solution at a temperature of 23±2° C. to remove the unwanted portion of the pre-baked coating film so as to form a specific pattern on the substrate. Specific examples of the developing solution include an alkaline aqueous solution of an alkaline compound such as sodium hydroxide, potassium hydroxide, sodium carbonate, sodium hydrogen carbonate, potassium carbonate, potassium hydrogen carbonate, sodium silicate, sodium methyl silicate, ammonia solution, ethylamine, diethylamine, dimethylethylanolamine, tetramethylammonium hydroxide, tetraethylammonium hydroxide, choline, pyrrole, piperidine, or 1,8-diazabicyclo-[5.4.0]-7-undecene. The concentration of the developing solution is 0.001 wt % to 10 wt %, preferably 0.005 wt % to 5 wt %, and more preferably 0.01 wt % to 1 wt %.

After the pre-baked coating film is developed, the substrate having a specific pattern is rinsed with water, and then the specific pattern is air dried with compressed air or compressed nitrogen. Then, a post-bake treatment (i.e., a heat treatment) is performed with a heating apparatus such as a hot plate or an oven. The post-bake temperature is 100 to 280° C., and the heating time is 1 minute to 15 minutes so as to remove the volatile components in the coating film and to perform a thermosetting reaction on unreacted ethylenically unsaturated double bonds. After the treatment steps, a specific pattern can be fixed on the substrate, thereby forming a pixel color layer. The steps are repeated to form, for instance, red, green, and blue pixel color layers on the substrate in sequence.

Lastly, an ITO (indium tin oxide) protective film (evaporated film) is formed on the surface of the pixel color layers via sputtering in a vacuum environment at a temperature of 220° C. to 250° C. When needed, the ITO protective film is etched and wired, and a liquid crystal alignment film (polyimide for a liquid crystal alignment film) is coated on the surface of the ITO protective film to form a color filter having a pixel layer.

### <Method for Manufacturing Liquid Crystal Display Apparatus>

First, the color filter formed by the method for forming a color filter and a substrate provided with a thin film transistor (TFT) are disposed opposite to each other, and a gap (cell gap) is left between the two. Then, the color filter and the peripheral portion of the substrate are laminated with an adhesive and an injection hole is left. Then, a liquid crystal is injected into the gap separated by the substrate surface and the adhesive through the injection hole, and then the injection hole is sealed to form a liquid crystal layer. Then, a polarizer is provided to each of the other side of the color filter in contact with the liquid crystal layer and the other side of the substrate in contact with the liquid crystal layer to form a liquid crystal display device. Next, a surface light source is disposed on one side of the liquid crystal display device to form a liquid crystal display apparatus. The liquid crystal used, i.e., a liquid crystal compound or a liquid crystal composition, is not particularly limited, and any liquid crystal compound or liquid crystal composition can be used.

Moreover, the liquid crystal alignment film used in the fabrication of the color filter is used to limit the alignment of liquid crystal molecules and is not particularly limited. Both inorganic matter and organic matter can be used, and the invention is not limited thereto.

### First Compound (A-1) Containing an Ethylenically Unsaturated Group

Preparation example A-1-1 to preparation example A-1-5 of the first compound (A-1) containing an ethylenically unsaturated group are described below:

### PREPARATION EXAMPLE A-1-1

Diacrylate of dicyclopentadiene dimethanol (made by Kyoeisha Chemical Co., Ltd., product name: light acrylate DCP-A, 30 g (0.099 moles)) was placed in a 100 ml three-neck flask provided with a thermometer, a dimroth condenser, and a stirrer. 26.1 g of cyclopentadiene (0.39 moles) obtained by decomposing dicyclopentadiene in advance at 150° C. was then added to the three-neck flask dropwise over 30 minutes while stirring at room temperature. After stirring for 20 hours, the contents in the three-neck flask were transferred to a 100 ml round-bottom flask, and the remaining unreacted cyclopentadiene was removed through distillation under reduced pressure. Next, the residue in the round-bottom flask was analyzed with NMR and bis(norbornenecarboxylate) of dicyclopentadiene dimethanol (DCPDN, first compound A-1-1 containing an ethylenically unsaturated group) used as the target product was confirmed.

The conditions of NMR are 270MHz of H-NMR; deuterated chloroform as solvent; room temperature as measuring temperature; and tetramethylsilane (TMS) as internal standard. Since the proton peaks of C═C bonds of the acryloyl group in the raw materials near 5.8-6.5 ppm disappeared, new proton peaks of the double bond portions of norbornene appeared near 5.9-6.2 ppm. Moreover, since proton peaks of the bridgehead position of norbornene appeared near 2.8-3 ppm, it was confirmed that bis(norbornenecarboxylate) of DCPDN having a norbornene skeleton was formed by adding cyclopentadiene on the acryloyl group in the raw materials through a Diels-Alder reaction.

### PREPARATION EXAMPLE A-1-2

Pentaerythritol tetraacrylate (made by Toagosei Co., product name: ARONIX M450, 30 g (0.085 moles)) was placed in a 100 ml three-neck flask provided with a thermometer, a dimroth condenser, and a stirrer. 49.5 g of cyclopentadiene (0.75 moles) obtained by decomposing dicyclopentadiene in advance at 150° C. was then added to the three-neck flask dropwise over 30 minutes while stirring at room temperature. After stirring for 20 hours, the contents in the three-neck flask were transferred to a 100 ml round-bottom flask, and the remaining unreacted cyclopentadiene was removed through distillation under reduced pressure. Next, the residue in the round-bottom flask was analyzed with NMR and it was confirmed that the acryloyl group in the raw materials formed into pentaerythritol tetrakis(norbornenecarboxylate) having a norbornene skeleton (PETTN, first compound A-1-2 containing an ethylenically unsaturated group) through a Diels-Alder addition reaction of cyclopentadiene.

### PREPARATION EXAMPLE A-1-3

Trimethylolpropane triacrylate (made by Toagosei Co., product name: ARONIX M309, 30 g (0.10 moles)) was placed in a 100 ml three-neck flask provided with a thermometer, a dimroth condenser, and a stirrer. 41.3 g of cyclopentadiene (0.63 moles) obtained by decomposing dicyclopentadiene in advance at 150° C. was then added to the three-neck flask dropwise over 30 minutes while stirring at room temperature. After stirring for 20 hours, the contents in the three-neck flask were transferred to a 100 ml round-bottom flask, and the remaining unreacted cyclopentadiene was removed through distillation under reduced pressure. The residue in the round-bottom flask was analyzed with NMR and it was confirmed that the acryloyl group in the raw materials formed into trimethylolpropane tris(norbornenecarboxylate) having a norbornene skeleton (TMPTN, first compound A-1-3 containing an ethylenically unsaturated group) through a Diels-Alder addition reaction of cyclopentadiene.

### PREPARATION EXAMPLE A-1-4

400 g of dicyclopentadiene (made by Maruzen Petrochemical Co., Ltd., 98% purity) was placed in a reaction vessel provided with a Dean-Stark tube, a dimroth condenser, a thermometer, a nitrogen inlet, and a stirrer. Then, the system interior was replaced with nitrogen gas. Next, the dicyclopentadiene was heated to reflux temperature (150-170° C.) in a nitrogen atmosphere, and then cyclopentadiene generated in the Dean-Stark tube was distilled while the reaction was performed for 6 hours. Then, 300 g of the cyclopentadiene (75% yield) in a colorless and transparent viscous liquid state obtained through distillation was immediately cooled and then kept at 0° C.

173.6 g of dipentaerythritol hexaacrylate (made by Shin Nakamura Chemical Company, 98% purity) was placed in a reaction vessel provided with a dimroth condenser, a thermometer, a nitrogen inlet, and a stirrer. Then, the system interior was replaced with nitrogen gas. Next, the reaction vessel was cooled with a water bath in a nitrogen atmosphere, and the reaction vessel was stirred at an internal temperature of 10° C. Then, 178.5 g of the synthesized cyclopentadiene was added into the reaction vessel dropwise over 2 hours. After the dropwise addition was complete, the reaction vessel was heated to 30° C., and then reaction was performed for 4 hours. Then, at 0.008 MPa, the reaction vessel was heated to 70° C., and excess cyclopentadiene and moisture were distilled under reduced pressure. The obtained substance was 307.7 g of a transparent viscous liquid (87% yield), i.e, the first compound A-1-4 containing an ethylenically unsaturated group. The purity of the first compound A-1-4 containing an ethylenically unsaturated group was 95% (determined through gel permeation chromatography (GPC)).

Moreover, the stereoisomer ratios of the first compound A-1-4 containing an ethylenically unsaturated group were analyzed by ¹³C-NMR to be endo body:exo body=81:19 and endo body/exo body=4.3. More specifically, the analysis results of the first compound A-1-4 containing an ethylenically unsaturated group are as shown below.

¹³C-NMR(CDCl₃, TMS, δppm):

endo body: 28.79, 42.11, 42.88, 45.40, 49.29, 61.77, 69.73, 131.86, 137.56, 173.58.

exo body: 30.00, 41.24, 42.70, 46.00, 46.19, 61.77, 69.73, 135.24, 137.71, 175.12.

IR (liquid membrane technique, cm⁻¹): 3058.9, 2972.1, 1750.1, 1465.8, 1386.7, 1334.7, 1271.0, 1170.7, 1153.4, 1108.9, 1064.6, 1031.9, 906.5, 711.7.

Through the identification method above, the first compound A-1-4 containing an ethylenically unsaturated group was confirmed to be the compound represented by formula (7).

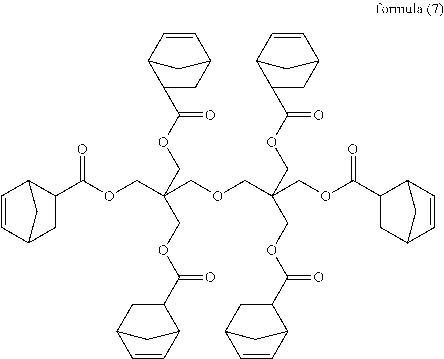 [SMILES: O=C(OCC(COCC(COC(=O)C1CC2C=CC1C2)(COC(=O)C1CC2C=CC1C2)COC(=O)C1CC2C=CC1C2)(COC(=O)C1CC2C=CC1C2)COC(=O)C1CC2C=CC1C2)C1CC2C=CC1C2]

### PREPARATION EXAMPLE A-1-5

The first compound containing an ethylenically unsaturated group of preparation example A-1-5 was prepared with the same steps of preparation example A-1-4. However, in preparation example A-1-5, 173.6 g of dipentaerythritol hexaacrylate was replaced by 198.6 g of dipentaerythritol hexamethacrylate. The first compound A-1-5 containing an ethylenically unsaturated group prepared in preparation example A-1-5 was a compound represented by formula (8).

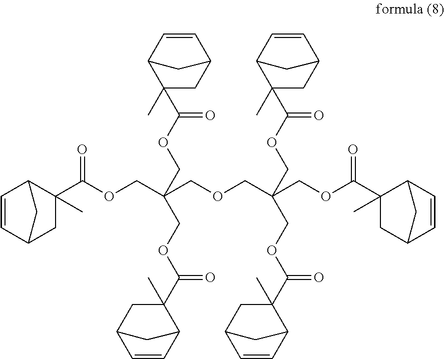 [SMILES: CC1(C(=O)OCC(COCC(COC(=O)C2(C)CC3C=CC2C3)(COC(=O)C2(C)CC3C=CC2C3)COC(=O)C2(C)CC3C=CC2C3)(COC(=O)C2(C)CC3C=CC2C3)COC(=O)C2(C)CC3C=CC2C3)CC2C=CC1C2]

### SYNTHESIS EXAMPLES OF FIRST ALKAI-SOLUBLE RESIN (B-1)

In the following, synthesis example B-1-1 to synthesis example B-1-3 of the first alkali-soluble resin (B-1) are described:

### SYNTHESIS EXAMPLE B-1-1

First, 100 parts by weight of a fluorene epoxy compound (model number: ESF-300, made by Nippon Steel Chemical, epoxy equivalent: 231), 30 parts by weight of acrylic acid, 0.3 parts by weight of benzyltriethylammonium chloride, 0.1 parts by weight of 2,6-di-t-butyl-p-cresol, and 130 parts by weight of propylene glycol monomethyl ether acetate were added in a 500 ml four-neck flask with a method of continuous addition. The feeding speed was controlled at 25 parts by weight/minute, the temperature of the reaction process was maintained at 100° C. to 110° C., and the mixture was reacted for 15 hours to obtain a light yellow transparent mixture solution having a solid content of 50 wt %.

Then, 100 parts by weight of the mixture solution was added to 25 parts by weight of ethylene glycol monoethyl ether acetate, and 6 parts by weight of tetrahydrophthalic anhydride and 13 parts by weight of benzophenone tetracarboxylic dianhydride were added at the same time. The mixture was then heated to 110° C. to 115° C. After reacting for 2 hours, the first alkali-soluble resin B-1-1 can be obtained, wherein the acid value thereof is 98 mgKOH/g and the weight-average molecular weight thereof is 2205.

### SYNTHESIS EXAMPLE B-1-2

100 parts by weight of a fluorene epoxy compound (made by Nippon Steel Chemical, model number: ESF-300, epoxy equivalent: 231), 30 parts by weight of acrylic acid, 0.3 parts by weight of benzyltriethylammonium chloride, 0.1 parts by weight of 2,6-di-t-butyl-p-cresol, and 130 parts by weight of propylene glycol monomethyl ether acetate were continuously added in a 500 ml four-neck flask. The feeding speed was controlled at 25 parts by weight/minute, the temperature of the reaction process was maintained at 100° C. to 110° C., and the mixture was reacted for 15 hours to obtain a light yellow transparent mixture solution having a solid content of 50 wt %.

Then, 100 parts by weight of the mixture solution was dissolved in 25 parts by weight of ethylene glycol monoethyl ether acetate, and 13 parts by weight of benzophenone tetracarboxylic dianhydride was added at the same time. The mixture was then heated to 90° C. to 95° C. After reacting for 2 hours, 6 parts by weight of tetrahydrophthalic anhydride was added, and the mixture was reacted at 90° C. to 95° C. for 4 hours to obtain the first alkali-soluble resin (C-1-2) having an acid value of 99.0 mgKOH/g and a weight-average molecular weight of 2630.

### SYNTHESIS EXAMPLE B-1-3

400 parts by weight of an epoxy compound (made by Nippon Kayaku Co., Ltd., model number: NC-3000, epoxy equivalent: 288), 102 parts by weight of acrylic acid, 0.3 parts by weight of methoxyphenol, 5 parts by weight of triphenylphosphine, and 264 parts by weight of propylene glycol monomethyl ether acetate were added in a reaction flask, wherein the temperature was maintained at 95° C. After reacting for 9 hours, an intermediate product was obtained, wherein the acid value thereof was 2.2 mgKOH/g. Then, 151 parts by weight of tetrahydrophthalic anhydride was added, and the mixture was reacted at 95° C. for 4 hours to obtain the first alkali-soluble resin (C-1-3) having an acid value of 102 mgKOH/g and a weight-average molecular weight of 3200.

### SYNTHESIS EXAMPLES OF SECOND ALKAI-SOLUBLE RESIN (B-2)

In the following, synthesis example B-2-1 to synthesis example B-2-4 of the second alkali-soluble resin (B-2) are described:

### SYNTHESIS EXAMPLE B-2-1

A nitrogen inlet, a stirrer, a heater, a condenser, and a thermometer were provided in a 1000 ml four-neck flask, and then nitrogen gas was introduced. Then, 45 parts by weight of 2-methacryloyloxyethyl succinate monoester (hereinafter HOMS), 15 parts by weight of dicyclopentenyl acrylate (hereinafter FA-511A), 20 parts by weight of a styrene monomer (hereinafter SM), 5 parts by weight of benzyl methacrylate (hereinafter BzMA), and 15 parts by weight of methyl methacrylate (hereinafter MMA) were dissolved in 200 parts by weight of EEP, wherein the feeding method of the monomer mixture was continuous addition.

After uniformly mixing, the temperature of the oil bath was increased to 100° C. Then, 6 parts by weight of a polymerization initiator 2,2′-azobis-2-methyl butyronitrile (abbreviated as AMBN hereinafter) was dissolved in EEP, and then the mixture was successively added to the four-neck flask in five equal parts over one hour.

The reaction temperature of the polymerization process was maintained at 100° C. After 6 hours, the polymerization product was removed from the four-neck flask and the solvent was devolatilized to obtain the second alkali-soluble resin B-2-1.

### SYNTHESIS EXAMPLE B-2-2 TO SYNTHESIS EXAMPLE B-2-4

The second alkali-soluble resins of synthesis example B-2-2 to synthesis example B-2-4 were prepared with the same steps as synthesis example B-2-1, and the difference is: the type, the usage amount, the reaction time, the reaction temperature, and the addition time of the reactants of the components of the second alkali-soluble resins were changed (as shown in Table 1), wherein the compounds corresponding to the labels in Table 1 are as follows. Moreover, in Table 1, “continuous addition” refers to continuously feeding monomers for copolymerization to the reaction vessel and continuously reacting and discharging; and “one-time addition” refers to completely feeding the monomers for copolymerization to the reaction vessel and completely discharging at once after the reaction was complete.
Abbreviation Component
HOMS 2-methacryloyloxyethyl succinate monoester
MAA methacrylic acid
AA acrylic acid
FA-511A dicyclopentenyl acrylate
FA-512A dicyclopentenyloxyethyl acrylate
SM styrene monomer
BzMA benzyl methacrylate
MMA methyl methacrylate
AMBN 2,2′-azobis-2-methyl butyronitrile
EEP ethyl 3-ethoxypropionate

TABLE 1

| | | | Synthesis example | | | |
|---|---|---|---|---|---|---|
| Second alkai-soluble resin | | | B-2-1 | B-2-2 | B-2-3 | B-2-4 |
| Monomer for | b-2-1 | HOMS | 45 | — | 20 | 30 |
| copolymeri- | | MAA | — | 35 | — | — |
| zation | | AA | — | — | 20 | — |
| (parts by | b-2-2 | FA511A | 15 | — | — | 35 |
| weight) | | FA512A | — | 35 | — | — |
| | | SM | 20 | — | 30 | — |
| | | BzMA | 5 | 30 | — | 35 |
| | | MMA | 15 | — | 30 | — |

| | | | | | |
|---|---|---|---|---|---|
| Polymerizing | AMBN | 6 | 5.5 | 6 | 6 |
| initiator (parts | | | | | |
| by weight) | | | | | |
| Solvent (parts | EEP | 200 | 200 | 200 | 200 |
| by weight) | | | | | |
| Polymeri- | Monomer | succes- | one- | succes- | one- |
| zation | input | sive | time | sive | time |
| condition | method | addition | addition | addition | addition |
| | Reaction | 100 | 105 | 100 | 105 |
| | temper- | | | | |
| | ature | | | | |
| | (° C.) | | | | |
| | Polymeri- | 6 | 6 | 5.5 | 6 |
| | zation | | | | |
| | time | | | | |
| | (hours) | | | | |

### EXAMPLES OF PHOTOSENSITIVE RESIN COMPOSITION

Example 1 to example 12 and comparative example 1 to comparative example 5 of the photosensitive resin composition are described below:

### EXAMPLE 1

10 parts by weight of the first compound A-1-1 containing an ethylenically unsaturated group (hereinafter A-1-1), 30 parts by weight of dipentaerythritol hexaacrylate (hereinafter A-2-1), 100 parts by weight of the second alkali-soluble resin B-2-1 (hereinafter B-2-1), 3 parts by weight of 2-methyl-1-(4-methylthiophenyl)-2-morpholino-1-propanone (hereinafter C-1), 7 parts by weight of 2,2′-bis(2,4-dichlorophenyl)-4,4′,5,5′-tetraphenyl-1,2′-biimidazole (hereinafter C-2), 5 parts by weight of 4,4′-bis(diethylamino)benzophenone (hereinafter C-3), and 60 parts by weight of a mixture of C.I. pigment red 254 and C.I. pigment yellow 139 (wherein the weight ratio of C.I. pigment red 254 and C.I. pigment yellow 139 is 80:20, hereinafter D-1) were added to 500 parts by weight of propylene glycol monomethyl ether acetate (hereinafter E-1). After uniformly stirring with a shaking-type stirrer, the photosensitive resin composition of example 1 was made. The obtained photosensitive resin composition was evaluated by each of the following evaluation methods, and the results are as shown in Table 2.

### EXAMPLE 2 TO EXAMPLE 12

The photosensitive resin compositions of example 2 to example 12 were prepared using the same steps as example 1, and the difference thereof is: the type and the usage amount of the components of the photosensitive resin compositions were changed (as shown in Table 2), wherein the compounds corresponding to the labels of Table 2 are as shown below. The obtained photosensitive resin compositions were evaluated by each of the following evaluation methods, and the results are as shown in Table 2.

| Abbre- | |
|---|---|
| viation | Component |
| A-1-1 | First compound A-1-1 containing an ethylenically |
| | unsaturated group |
| A-1-2 | First compound A-1-2 containing an ethylenically |
| | unsaturated group |
| A-1-3 | First compound A-1-3 containing an ethylenically |
| | unsaturated group |
| A-1-4 | First compound A-1-4 containing an ethylenically |
| | unsaturated group |
| A-1-5 | First compound A-1-5 containing an ethylenically |
| | unsaturated group |
| A-2-1 | dipentaerythritol hexaacrylate (DPHA) |
| A-2-2 | dipentaerythritol pentaacrylate (TO-1382) |
| A-2-3 | ethylene oxide(EO)-modified dipentaerythritol hexaacrylate |
| | (DPEA-12) |
| A-2-4 | caprolactone-modified dipentaerythritol hexaacrylate (DPCA-60) |
| C-1 | 2-methyl-1-(4-methylthiophenyl)-2-morpholino-1-propanone |
| C-2 | 2,2′-bis(2,4-dichlorophenyl)-4,4′,5,5′-tetraphenyl-1,2′-biimidazole |
| C-3 | 4,4′-bis(diethylamino)benzophenone |
| C-4 | 1[4-(phenylthio)phenypoctane-1,2-dion-2-(O-benzoyl oxime) |
| D-1 | C.I.Pigment R254/C.I.Pigment Y139 = 80/20 |
| D-2 | C.I.Pigment G36/C.I.Pigment Y150 = 60/40 |
| D-3 | C.I.Pigment B15:6 |
| D-4 | C.I.Pigment BK7 |
| E-1 | propylene glycol monomethyl ether acetate |
| E-2 | ethyl 3-ethoxypropionate |
| F-1 | 2,2-thiobis(4-methyl-6-tert-butylphenol) |
| F-2 | 2-(3-tert-butyl-5-methyl-2-hydroxyphenyl)-5-chlorophenyl azide |

### COMPARATIVE EXAMPLE 1 TO COMPARATIVE EXAMPLE 5

The photosensitive resin compositions of comparative example 1 to comparative example 5 were prepared using the same steps as example 1, and the difference thereof is: the type and the usage amount of the components of the photosensitive resin compositions were changed (as shown in Table 3). The obtained photosensitive resin compositions were evaluated by each of the following evaluation methods, and the results are as shown in Table 3.

### <Evaluation Methods>

### 1. High Precision Pattern Linearity

The photosensitive resin composition of each example and comparative example above was coated on a glass substrate having a length and a width of 100 mm with a spin coating method. Then, the glass substrate was dried at a reduced pressure of about 100 mmHg for about 30 seconds. Next, the glass substrate was prebaked at 80° C. for 3 minutes to form a pre-baked coating film having a film thickness of 2.5 μm. Then, the pre-baked coating film was irradiated with 300 mJ/cm² of ultraviolet with an exposure machine (made by Canon, Model PLA-501F) via a photomask having a stripe pattern and a width of 25 μm (pitch of 50 μm). After the ultraviolet irradiation, the pre-baked coating film was immersed in a developing solution at 23° C. for 2 minutes. Then, the pre-baked coating film was washed with pure water and post-baked at 200° C. for 80 minutes to form a photosensitive resin layer having a film thickness of 2.0 μm on the glass substrate.

The stripe pattern formed by the method above was observed using an optical microscope, and high precision pattern linearity was evaluated according to the following criteria.

⊚: 90% or more of stripe pattern have good linearity.

◯: 80% to 89% of stripe pattern have good linearity.

Δ: 70% to 79% of stripe pattern have good linearity.

×: less than 70% of stripe pattern have good linearity.

### 2. Alkali Solution Resistance

The photosensitive resin compositions were coated on a glass substrate having a length and a width of 100 mm with a spin coating method. The glass substrate was dried at a reduced pressure of about 100 mmHg for about 30 seconds. Next, the glass substrate was prebaked at 80° C. for 2 minutes to form a pre-baked coating film having a film thickness of 2.5 μm.

Then, the pre-baked coating film was irradiated with 100 mJ/cm² of ultraviolet with an exposure machine (made by Canon, Model PLA-501F). Next, the pre-baked coating film was post-baked at 235° C. for 30 minutes to form a photosensitive resin layer having a film thickness of 2.0 μm on the glass substrate. Then, the chromaticity (L*, a*, and b*) thereof was measured using a colorimeter (made by Otsuka Electronics Co., Ltd., Model MCPD). The post-baked coating film was immersed in an alkaline solution (potassium hydroxide, 0.5 wt %) at 23° C. for 60 minutes, and then the chromaticity thereof was determined again. The chromaticity variation before the coating film was immersed in the alkaline solution and after the coating film was immersed in the alkaline solution was defined as the color difference of alkali solution resistance by formula (9), and a color difference ΔEab* of alkali solution resistance was evaluated according to the following criteria.

ΔEab*=[(ΔL)²+(Δa)²+(Δb)²]^{1/2} formula (9)

⊚: color difference ΔEab* of alkali solution resistance <2.

◯: 2≦color difference ΔEab* of alkali solution resistance <4.

Δ: 4≦color difference ΔEab* of alkali solution resistance <6.

×: 6≦color difference ΔEab* of alkali solution resistance.

TABLE 2

Example

| Component | | | 1 | 2 | 3 | 4 | 5 | 6 |
|---|---|---|---|---|---|---|---|---|
| Compound (A) | A-1 | A-1-1 | 10 | — | — | — | — | 60 |
| containing an | | A-1-2 | — | 20 | — | — | — | — |
| ethylenically | | A-1-3 | — | — | 30 | — | — | — |
| unsaturated | | A-1-4 | — | — | — | 40 | — | — |
| group (parts | | A-1-5 | — | — | — | — | 50 | — |
| by weight) | A-2 | A-2-1 | 30 | — | — | — | — | 100 |
| | | A-2-2 | — | 20 | — | — | — | — |
| | | A-2-3 | — | — | 10 | — | — | — |
| | | A-2-4 | — | — | — | — | 50 | — |
| Alkali-soluble | B-1 | B-1-1 | — | 3 | — | — | 10 | — |
| resin (B) | | B-1-2 | — | — | 5 | — | — | 15 |
| (parts by | | B-1-3 | — | — | — | 10 | — | — |
| weight) | B-2 | B-2-1 | 100 | 97 | — | — | 10 | — |
| | | B-2-2 | — | — | 95 | — | — | 85 |
| | | B-2-3 | — | — | — | 90 | — | — |
| | | B-2-4 | — | — | — | — | 80 | — |

| | | | | | | | |
|---|---|---|---|---|---|---|---|
| Photoinitiator | C-1 | 3 | 10 | — | 5 | 20 | — |
| (C) | C-2 | 7 | 5 | 5 | 5 | 30 | 5 |
| (parts by | C-3 | 5 | — | — | — | — | 25 |
| weight) | C-4 | — | — | 10 | 5 | — | 20 |
| Pigment (D) | D-1 | 60 | — | — | — | 120 | — |
| (parts by | D-2 | — | 80 | — | — | — | 180 |
| weight) | D-3 | — | — | 100 | — | — | — |
| | D-4 | — | — | — | 120 | — | — |
| Organic | E-1 | 500 | — | 1000 | 500 | 1000 | 2000 |
| solvent (E) | E-2 | — | 1000 | — | 500 | 500 | — |
| (parts by | | | | | | | |
| weight) | | | | | | | |
| Additive (F) | F-1 | 0.01 | — | — | — | — | — |
| | F-2 | — | — | — | — | — | 1 |
| Evaluation | High precision | ◯ | ⊚ | ⊚ | ⊚ | ⊚ | ⊚ |
| results | pattern linearity | | | | | | |
| | Alkali solution | ⊚ | ⊚ | ⊚ | ⊚ | ⊚ | ⊚ |
| | resistance | | | | | | |

| | | | Example | | | | | |
|---|---|---|---|---|---|---|---|---|
| Component | | | 7 | 8 | 9 | 10 | 11 | 12 |
| Compound (A) | A-1 | A-1-1 | — | — | — | — | 50 | — |
| containing an | | A-1-2 | 70 | — | — | — | 50 | — |
| ethylenically | | A-1-3 | — | 80 | — | — | — | 70 |
| unsaturated | | A-1-4 | — | — | 90 | — | — | 30 |
| group (parts | | A-1-5 | — | — | — | 100 | — | — |
| by weight) | A-2 | A-2-1 | — | — | — | — | 50 | — |
| | | A-2-2 | 150 | — | — | — | — | 300 |
| | | A-2-3 | — | 200 | — | — | 250 | — |
| | | A-2-4 | — | — | 100 | 200 | — | — |
| Alkali-soluble | B-1 | B-1-1 | — | 10 | 20 | — | — | 100 |
| resin (B) | | B-1-2 | — | 20 | — | 50 | — | — |
| (parts by | | B-1-3 | 20 | — | 20 | — | 60 | — |
| weight) | B-2 | B-2-1 | — | 20 | — | — | — | — |
| | | B-2-2 | — | — | 60 | — | — | — |
| | | B-2-3 | 80 | — | — | 50 | — | — |
| | | B-2-4 | — | 50 | — | — | 40 | — |

| | | | | | | | |
|---|---|---|---|---|---|---|---|
| Photoinitiator | C-1 | 10 | 30 | — | 30 | 50 | 70 |
| (C) | C-2 | 30 | 40 | 40 | 40 | 80 | 80 |
| (parts by | C-3 | 20 | — | — | — | — | — |
| weight) | C-4 | — | — | 40 | 40 | — | — |
| Pigment (D) | D-1 | — | — | 240 | — | — | — |
| (parts by | D-2 | — | — | — | 360 | — | — |
| weight) | D-3 | 240 | — | — | — | 480 | — |
| | D-4 | — | 300 | — | — | — | 600 |
| Organic | E-1 | 1000 | 1500 | 3000 | 3500 | — | — |
| solvent (E) | E-2 | 1000 | 1000 | — | — | 4500 | 5000 |
| (parts by | | | | | | | |
| weight) | | | | | | | |
| Additive (F) | F-1 | — | — | — | — | — | 5 |
| | F-2 | — | — | — | — | — | — |
| Evaluation | High precision | ⊚ | ⊚ | ⊚ | ⊚ | ⊚ | ◯ |
| results | pattern linearity | | | | | | |
| | Alkali solution | ⊚ | ⊚ | ⊚ | ⊚ | ⊚ | ⊚ |
| | resistance | | | | | | |

TABLE 3

| | | | Comparative example | | | | |
|---|---|---|---|---|---|---|---|
| Component | | | 1 | 2 | 3 | 4 | 5 |
| Compound (A) | A-1 | A-1-1 | — | — | — | — | — |
| containing an | | A-1-2 | — | — | — | — | — |
| ethylenically | | A-1-3 | — | — | — | — | — |
| unsaturated | | A-1-4 | — | — | — | — | — |
| group (parts | | A-1-5 | — | — | — | — | — |
| by weight) | A-2 | A-2-1 | 150 | — | — | — | 200 |
| | | A-2-2 | — | 160 | — | — | — |
| | | A-2-3 | — | — | 170 | — | — |
| | | A-2-4 | — | — | — | 180 | — |
| Alkali-soluble | B-1 | B-1-1 | 100 | — | — | — | 30 |
| resin (B) | | B-1-2 | — | 100 | — | — | — |
| (parts by | | B-1-3 | — | — | 100 | — | — |
| weight) | B-2 | B-2-1 | — | — | — | 100 | — |
| | | B-2-2 | — | — | — | — | 70 |
| | | B-2-3 | — | — | — | — | — |
| | | B-2-4 | — | — | — | — | — |

| | | | | | | |
|---|---|---|---|---|---|---|
| Photoinitiator | C-1 | 10 | 30 | — | 15 | 20 |
| (C) | C-2 | 20 | 20 | 25 | 15 | 30 |
| (parts by | C-3 | 20 | — | — | — | — |
| weight) | C-4 | — | — | 25 | 15 | — |
| Pigment (D) | D-1 | 100 | — | — | — | 240 |
| (parts by | D-2 | — | 120 | — | — | — |
| weight) | D-3 | — | — | 160 | — | — |
| | D-4 | — | — | — | 200 | — |
| Organic | E-1 | 2500 | — | 2000 | 1500 | 1000 |
| solvent (E) | E-2 | — | 2000 | — | 500 | 1500 |
| (parts by | | | | | | |
| weight) | | | | | | |
| Additive (F) | F-1 | — | — | — | — | — |
| | F-2 | — | — | — | — | — |
| Evaluation | High precision | Δ | Δ | Δ | Δ | ◯ |
| results | pattern linearity | | | | | |
| | Alkali solution | X | X | X | X | X |
| | resistance | | | | | |

### <Evaluation Results>

It can be known from Table 2 and Table 3 that, in comparison to the photosensitive resin compositions containing the first compound (A-1) containing an ethylenically unsaturated group (example 1 to example 12), the alkali solution resistance of the photosensitive resin compositions without the first compound (A-1) containing an ethylenically unsaturated group (comparative example 1 to comparative example 5) is worse.

Moreover, the high precision pattern linearity of the photosensitive resin compositions containing the first alkali-soluble resin (B-1) or the second alkali-soluble resin (B-2) (examples 1 and 12) is good. The high precision pattern linearity of the photosensitive resin compositions containing the first alkali-soluble resin (B-1) and the second alkali-soluble resin (B-2) at the same time (example 2 to example 11) is even better.

Based on the above, in the invention, by adding the first compound (A-1) containing an ethylenically unsaturated group having two or more groups represented by formula (1) and not having an aromatic skeleton, the known issues of poor high precision pattern linearity and alkali solution resistance can be solved. In other words, since the photosensitive resin composition of the invention contains a specific compound containing an ethylenically unsaturated group and a specific alkali-soluble resin, the photosensitive resin composition has the features of high precision pattern linearity and good alkali solution resistance. As a result, the photosensitive resin composition is suitable for a color filter and a liquid crystal display apparatus.

Although the present invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A photosensitive resin composition for a color filter, comprising:
a compound (A) containing an ethylenically unsaturated group;
an alkai-soluble resin (B);
a photoinitiator (C);
a pigment (D); and
an organic solvent (E),
wherein the compound (A) containing an ethylenically unsaturated group comprises a first compound (A-1) containing an ethylenically unsaturated group, and the first compound (A-1) containing an ethylenically unsaturated group has two or more groups represented by formula (1) and does not have an aromatic skeleton; 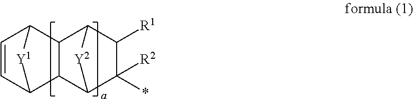
in formula (1), Y¹ and Y² each independently represent a methylene group, an ethylidene group, an isopropylidene group, an oxygen atom, or a sulfur atom; R¹ represents a hydrogen atom, an alkyl group, or a carboxyl group or a derivative group thereof; R² represents a hydrogen atom, a cyano group, an alkyl group, a substituted alkyl group, or a carboxyl group or a derivative group thereof; a represents an integer of 0 to 5; and * represents a bonding position.

2. The photosensitive resin composition for the color filter according to claim 1, wherein the the first compound (A-1) containing an ethylenically unsaturated group comprises a compound represented by formula (2), a compound represented by formula (3), or a combination of the two, 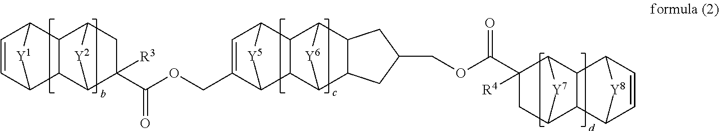
in formula (2), Y³, Y⁴, Y⁵, Y⁶, Y⁷, and Y⁸ each independently represent a methylene group, an ethylidene group, an isopropylidene group, an oxygen atom, or a sulfur atom; b, c, and d each independently represent an integer of 0 to 5; and R³ and R⁴ each independently represent a hydrogen atom or a methyl group, 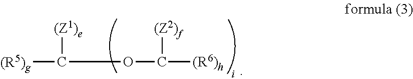
in formula (3), R⁵ and R⁶ each independently represent a C₁ to C₅ alkyl group; Z¹ and Z² each independently represent a group represented by formula (4); e represents an integer of 1 to 4; g represents an integer of 0 to 2; f and h each independently represent an integer of 0 to 3; and i represents an integer of 0 or 1, 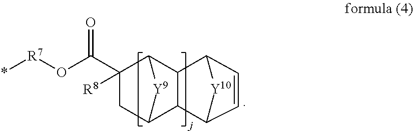
in formula (4), R⁷ represents a C₁ to C₄ alkylene group, a residue of alkylene glycol, or a residue of polyalkylene glycol; R⁸ represents a hydrogen atom or a methyl group; Y⁹ and Y¹⁰ each independently represent a methylene group, an ethylidene group, an isopropylidene group, an oxygen atom, or a sulfur atom; j represents an integer of 0 to 5; and * represents a bonding position.

3. The photosensitive resin composition for the color filter according to claim 1, wherein the alkali-soluble resin (B) comprises a first alkali-soluble resin (B-1) and the first alkali-soluble resin (B-1) is obtained by reacting a first mixture, the first mixture comprising:
an epoxy compound (b-1-1) having at least two epoxy groups; and
a compound (b-1-2) having at least one carboxylic acid group and at least one ethylenically unsaturated group.

4. The photosensitive resin composition for the color filter according to claim 3, wherein the epoxy compound (b-1-1) having at least two epoxy groups comprises a compound represented by formula (5), a compound represented by formula (6), or a combination of the two, 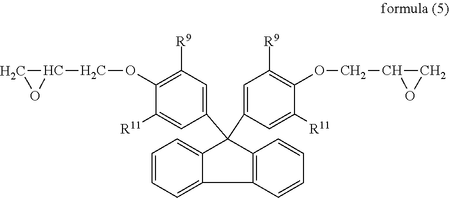
in formula (5), R⁹, R¹⁰, R¹¹, and R¹² each independently represent a hydrogen atom, a halogen atom, a C₁ to C₅ alkyl group, a C₁ to C₅ alkoxy group, a C₆ to C₁₂ aryl group, or a C₆ to C₁₂ aralkyl group, 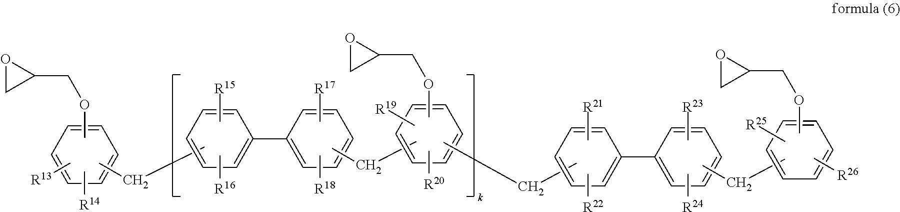
in formula (6), R¹³ to R²⁶ each independently represent a hydrogen atom, a halogen atom, a C₁ to C₈ alkyl group, or a C₆ to C₁₅ aromatic group, and k represents an integer of 0 to 10.

5. The photosensitive resin composition for the color filter according to claim 3, wherein based on a usage amount of 100 parts by weight of the alkali-soluble resin (B), a usage amount of the first alkali-soluble resin (B-1) is 3 parts by weight to 60 parts by weight.

6. The photosensitive resin composition for the color filter according to claim 3, wherein the alkali-soluble resin (B) further comprises a second alkali-soluble resin (B-2) and the second alkali-soluble resin (B-2) is obtained by reacting a second mixture, the second mixture comprising:
an ethylenically unsaturated monomer (b-2-1) having at least one carboxylic acid group; and
other copolymerizable ethylenically unsaturated monomers (b-2-2).

7. The photosensitive resin composition for the color filter according to claim 6, wherein based on a usage amount of 100 parts by weight of the alkali-soluble resin (B), a usage amount of the second alkali-soluble resin (B-2) is 40 parts by weight to 97 parts by weight.

8. The photosensitive resin composition for the color filter according to claim 1, wherein based on a usage amount of 100 parts by weight of the alkali-soluble resin (B), a usage amount of the first compound (A-1) containing an ethylenically unsaturated group is 10 parts by weight to 100 parts by weight.

9. The photosensitive resin composition for the color filter according to claim 1, wherein based on a usage amount of 100 parts by weight of the alkai-soluble resin (B), a usage amount of the compound (A) containing an ethylenically unsaturated group is 40 parts by weight to 400 parts by weight, a usage amount of the photoinitiator (C) is 15 parts by weight to 150 parts by weight, a usage amount of the pigment (D) is 60 parts by weight to 600 parts by weight, and a usage amount of the organic solvent (E) is 500 parts by weight to 5000 parts by weight.

10. A method for manufacturing a color filter, wherein the method comprises using a pixel layer formed by the photosensitive resin composition for the color filter of claim 1.

11. A color filter obtained by the method of claim 10.

12. A liquid crystal display apparatus, comprising the color filter of claim 11.
